(19) United States
(12) Patent Application Publication
(10) Pub. No.: US 2026/0333332 A1
(43) Pub. Date: Oct. 22, 2026

(54) SIGNALING AND OPERATIONS FOR DYNAMIC BANDWIDTH EXPANSION (DBE)

(71) Applicant: QUALCOMM Incorporated, San Diego, CA (US)

(72) Inventors: Gaurang NAIK, San Diego, CA (US); Abhishek Pramod PATIL, San Diego, CA (US); Alfred ASTERJADHI, San Diego, CA (US); George CHERIAN, San Diego, CA (US); Sai Yiu Duncan HO, San Diego, CA (US); Giovanni CHISCI, San Diego, CA (US); Sanket Sanjay KALAMKAR, San Diego, CA (US); Sherief HELWA, San Diego, CA (US); Naveen Kumar KAKANI, Flower Mound, TX (US); Jinsung LEE, San Jose, CA (US); Youhan KIM, Saratoga, CA (US)

(21) Appl. No.: 19/404,787

(22) Filed: Dec. 1, 2025

Related U.S. Application Data
(60) Provisional application No. 63/791,302, filed on Apr. 18, 2025.

(51) Int. Cl. H04W 72/0457

(52) U.S. Cl. CPC H04W 72/0457

(57) ABSTRACT

This disclosure provides methods, components, devices, and systems that support signaling and operations for dynamic bandwidth expansion (DBE). Some aspects more specifically relate to enabling a DBE mode at a wireless device. In some examples, an access point (AP) may transmit a first signal that indicates support for the DBE mode at the AP. The DBE mode may enable the AP to communicate frames via a DBE operating bandwidth with a bandwidth size relatively larger than the bandwidth size of a basic service set (BSS) operating bandwidth. The AP may transmit a second signal that enables the DBE mode at the AP. A STA that supports DBE operations may receive the second signal and may determine that the AP is switching to the DBE operating bandwidth. The STA may enable the DBE mode and may communicate with the AP via the DBE operating bandwidth based on the second signal.

### CROSS REFERENCES

The present Application for Patent claims benefit of U.S. Provisional Patent Application No. 63/791,302 by KAIK et al., entitled “SIGNALING AND OPERATIONS FOR DYNAMIC BANDWIDTH EXPANSION (DBE),” filed Apr. 18, 2025, assigned to the assignee hereof, and which is expressly incorporated by reference in its entirety herein.

### TECHNICAL FIELD

This disclosure relates generally to wireless communication and, more specifically, to signaling and operations for dynamic bandwidth expansion (DBE).

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication at an access point (AP) station (STA). The method may include transmitting, via a first operating bandwidth with a first bandwidth size, a first signal that indicates support for a dynamic bandwidth expansion (DBE) mode at the AP STA, where the first operating bandwidth is associated with the DBE mode being disabled at the AP STA. The method may further include transmitting, via the first operating bandwidth, a second signal that indicates enablement of the DBE mode at the AP STA and communicating with a non-AP STA via a second operating bandwidth with a second bandwidth size based on the second signal, where the second bandwidth size is greater than the first bandwidth size based on a DBE bandwidth size capability of the AP STA, and where the second operating bandwidth is associated with the DBE mode being enabled at the AP STA.

Another innovative aspect of the subject matter described in this disclosure can be implemented in an AP STA. The AP STA may include a processing system that includes processor circuitry and memory circuitry that stores code. The processing system may be configured to cause the AP STA to transmit, via a first operating bandwidth with a first bandwidth size, a first signal that indicates support for a DBE mode at the AP STA, where the first operating bandwidth is associated with the DBE mode being disabled at the AP STA. The processing system may be further configured to cause the AP STA to transmit, via the first operating bandwidth, a second signal that indicates enablement of the DBE mode at the AP STA and communicate with a non-AP STA via a second operating bandwidth with a second bandwidth size based on the second signal, where the second bandwidth size is greater than the first bandwidth size based on a DBE bandwidth size capability of the AP STA, and where the second operating bandwidth is associated with the DBE mode being enabled at the AP STA.

Another innovative aspect of the subject matter described in this disclosure can be implemented in an AP STA for wireless communication. The AP STA may include means for transmitting, via a first operating bandwidth with a first bandwidth size, a first signal that indicates support for a DBE mode at the AP STA, where the first operating bandwidth is associated with the DBE mode being disabled at the AP STA. The AP STA may further include means for transmitting, via the first operating bandwidth, a second signal that indicates enablement of the DBE mode at the AP STA and means for communicating with a non-AP STA via a second operating bandwidth with a second bandwidth size based on the second signal, where the second bandwidth size is greater than the first bandwidth size based on a DBE bandwidth size capability of the AP STA, and where the second operating bandwidth is associated with the DBE mode being enabled at the AP STA.

Another innovative aspect of the subject matter described in this disclosure can be implemented in a non-transitory computer-readable medium storing code for wireless communication. The code may include instructions executable by one or more processors to transmit, via a first operating bandwidth with a first bandwidth size, a first signal that indicates support for a DBE mode at the AP STA, where the first operating bandwidth is associated with the DBE mode being disabled at the AP STA. The code may include instructions further executable by the one or more processors to transmit, via the first operating bandwidth, a second signal that indicates enablement of the DBE mode at the AP STA and communicate with a non-AP STA via a second operating bandwidth with a second bandwidth size based on the second signal, where the second bandwidth size is greater than the first bandwidth size based on a DBE bandwidth size capability of the AP STA, and where the second operating bandwidth is associated with the DBE mode being enabled at the AP STA.

Some examples of the method, AP STAs, and non-transitory computer-readable medium described herein may further include operations, features, means, or instructions for enabling the DBE mode at the AP STA based on the second signal and updating an operating bandwidth of the AP STA from the first operating bandwidth to the second operating bandwidth based on the enabled DBE mode at the AP STA, where the communicating with the non-AP STA via the second operating bandwidth may be further based on the updating the operating bandwidth of the AP STA.

In some examples of the method, AP STAs, and non-transitory computer-readable medium described herein, the second signal further indicates a time associated with the enablement of the DBE mode at the AP STA and the operating bandwidth of the AP STA may be updated from the first operating bandwidth to the second operating bandwidth at the time.

Some examples of the method, AP STAs, and non-transitory computer-readable medium described herein may further include operations, features, means, or instructions for receiving an action frame that indicates a first enablement of the DBE mode at the non-AP STA based on the DBE mode being disabled at the AP STA, where the communicating with the non-AP STA via the second operating bandwidth may be further based on the first enablement of the DBE mode at the non-AP STA.

Some other examples of the method, AP STAs, and non-transitory computer-readable medium described herein may further include operations, features, means, or instructions for receiving an action frame that indicates a second enablement of the DBE mode at the non-AP STA based on the DBE mode being enabled at the AP STA, where the communicating with the non-AP STA via the second operating bandwidth may be further based on the second enablement of the DBE mode at the non-AP STA.

In some examples of the method, AP STAs, and non-transitory computer-readable medium described herein, the first operating bandwidth includes a basic service set (BSS) operating bandwidth, and the second operating bandwidth includes a DBE operating bandwidth corresponding to the DBE bandwidth size capability of the AP STA or a subband of the DBE operating bandwidth.

Another innovative aspect of the subject matter described in this disclosure can be implemented in a method for wireless communication at a non-AP STA. The method may include receiving, via a first operating bandwidth with a first bandwidth size, a first signal that indicates support for a DBE mode at an AP STA, where the first operating bandwidth is associated with the DBE mode being disabled at the AP STA. The method may further include receiving, via the first operating bandwidth, a second signal that indicates enablement of the DBE mode at the AP STA and communicating with the AP STA via a second operating bandwidth with a second bandwidth size based on the second signal, where the second bandwidth size is greater than the first bandwidth size based on a DBE bandwidth size capability of the non-AP STA, and where the second operating bandwidth is associated with the DBE mode being enabled at the AP STA.

Another innovative aspect of the subject matter described in this disclosure can be implemented in a non-AP STA. The non-AP STA may include a processing system that includes processor circuitry and memory circuitry that stores code. The processing system may be configured to cause the non-AP STA to receive, via a first operating bandwidth with a first bandwidth size, a first signal that indicates support for a DBE mode at an AP STA, where the first operating bandwidth is associated with the DBE mode being disabled at the AP STA. The processing system may be further configured to cause the non-AP STA to receive, via the first operating bandwidth, a second signal that indicates enablement of the DBE mode at the AP STA and communicate with the AP STA via a second operating bandwidth with a second bandwidth size based on the second signal, where the second bandwidth size is greater than the first bandwidth size based on a DBE bandwidth size capability of the non-AP STA, and where the second operating bandwidth is associated with the DBE mode being enabled at the AP STA.

Another innovative aspect of the subject matter described in this disclosure can be implemented in another non-AP STA for wireless communication. The non-AP STA may include means for receiving, via a first operating bandwidth with a first bandwidth size, a first signal that indicates support for a DBE mode at an AP STA, where the first operating bandwidth is associated with the DBE mode being disabled at the AP STA. The non-AP STA may further include means for receiving, via the first operating bandwidth, a second signal that indicates enablement of the DBE mode at the AP STA and means for communicating with the AP STA via a second operating bandwidth with a second bandwidth size based on the second signal, where the second bandwidth size is greater than the first bandwidth size based on a DBE bandwidth size capability of the non-AP STA, and where the second operating bandwidth is associated with the DBE mode being enabled at the AP STA.

Another innovative aspect of the subject matter described in this disclosure can be implemented in a non-transitory computer-readable medium storing code for wireless communication. The code may include instructions executable by one or more processors to receive, via a first operating bandwidth with a first bandwidth size, a first signal that indicates support for a DBE mode at an AP STA, where the first operating bandwidth is associated with the DBE mode being disabled at the AP STA. The code may further include instructions executable by the one or more processors to receive, via the first operating bandwidth, a second signal that indicates enablement of the DBE mode at the AP STA and communicate with the AP STA via a second operating bandwidth with a second bandwidth size based on the second signal, where the second bandwidth size is greater than the first bandwidth size based on a DBE bandwidth size capability of the non-AP STA, and where the second operating bandwidth is associated with the DBE mode being enabled at the AP STA.

Some examples of the method, non-AP STAs, and non-transitory computer-readable medium described herein may further include operations, features, means, or instructions for transmitting an action frame that indicates a first enablement of the DBE mode at the non-AP STA based on the DBE mode being disabled at the AP STA, where the communicating with the AP STA via the second operating bandwidth may be further based on the first enablement of the DBE mode at the non-AP STA.

Some examples of the method, non-AP STAs, and non-transitory computer-readable medium described herein may further include operations, features, means, or instructions for transmitting an action frame that indicates a second enablement of the DBE mode at the non-AP STA based on the enablement of the DBE mode at the AP STA, where the communicating with the AP STA via the second operating bandwidth may be further based on the second enablement of the DBE mode at the non-AP STA.

Some examples of the method, non-AP STAs, and non-transitory computer-readable medium described herein may further include operations, features, means, or instructions for transmitting, via the first operating bandwidth, a third signal that indicates support for the DBE mode at the non-AP STA, where the communicating with the AP STA via the second operating bandwidth may be further based on the third signal.

In some examples of the method, non-AP STAs, and non-transitory computer-readable medium described herein, the first operating bandwidth includes a BSS operating bandwidth and the second operating bandwidth includes a DBE operating bandwidth corresponding to the DBE bandwidth size capability of the non-AP STA or a subband of the DBE operating bandwidth.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a signaling diagram that supports signaling and operations for dynamic bandwidth expansion (DBE).

FIG. 6 shows an example timeline that supports DBE enablement and disablement for a wireless AP and a wireless STA.

FIG. 7 shows an example timeline of frame exchanges that supports a DBE mode.

FIG. 8 shows an example of a channelization that supports a DBE mode.

FIGS. 9 and 10 show block diagrams of example wireless communication devices that support signaling and operations for DBE.

FIG. 11 shows a flowchart illustrating an example process performable by or at a wireless AP that supports signaling and operations for DBE.

FIG. 12 shows a flowchart illustrating an example process performable by or at a wireless STA that supports signaling and operations for DBE.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, multiple wireless devices may communicate via a frequency band. For example, a wireless network may include multiple wireless access points (APs) that coordinate communications and resources to efficiently utilize the frequency spectrum. In some examples, to effectively share the frequency spectrum, an AP may communicate with one or more wireless stations (STAs) via a basic service set (BSS) operating bandwidth with a bandwidth size that is less than the AP's threshold (e.g., maximum) bandwidth size capability. For example, the AP may use a BSS operating bandwidth that spans 80 megahertz (MHz) to avoid (or otherwise mitigate) collisions and interference with other APs and STAs communicating via the same frequency band. However, in some systems, the amount of traffic communicated via the frequency band may vary over time, such that frequency resources may be underutilized during some time periods if the AP is operating via the BSS operating bandwidth (e.g., below the AP's threshold bandwidth size capability).

Various aspects relate generally to supporting dynamic bandwidth expansion (DBE) operations. Some aspects more specifically relate to signaling that enables a DBE mode at a wireless STA, such as an AP STA, a non-AP STA, or both. In some examples, an AP may operate with a DBE mode disabled. For example, the AP may communicate via a first operating bandwidth (e.g., a BSS operating bandwidth) with a first bandwidth size (e.g., 80 MHz). The AP may transmit, via the first operating bandwidth, a first signal that indicates support for the DBE mode at the AP. A STA that supports DBE operations may receive the first signal and may determine that the AP supports the DBE mode. To switch to an expanded bandwidth, the AP may transmit a second signal that indicates enablement of the DBE mode at the AP. The expanded bandwidth may be an example of a second operating bandwidth (e.g., a DBE operating bandwidth) with a second bandwidth size that is different from the first bandwidth size. For example, the DBE operating bandwidth may have a bandwidth size of 160 MHz or 320 MHz. In some examples, the second signal may additionally indicate a time at which the AP will complete the switch to the second operating bandwidth. The STA may receive the second signal and may determine that the AP is enabling the DBE mode at the AP. The STA may similarly enable the DBE mode at the STA. In some examples, the STA may enable the DBE mode after the AP enables the DBE mode. In some other examples, the STA may enable the DBE mode independent of the AP's currently active mode (e.g., even if the AP is operating with the DBE mode disabled). If the AP and the STA have both enabled the DBE mode, the AP and the STA may communicate via the second operating bandwidth (e.g., the DBE operating bandwidth spanning 160 or 320 MHz). In some examples, the AP, the STA, or both may semi-statically or dynamically switch between the DBE mode being enabled and the DBE mode being disabled to switch a bandwidth size of an operating bandwidth.

Particular aspects of the subject matter described in this disclosure can be implemented to realize one or more of the following potential advantages. In some examples, by supporting DBE operations, the described techniques can be used to increase throughput for an AP, a STA, or both. For example, expanding an operating bandwidth from a BSS operating bandwidth (e.g., spanning 80 MHz) to a DBE operating bandwidth (e.g., spanning 160 or 320 MHz) may support improved signal throughput by increasing the utilization of frequency resources. Additionally, or alternatively, by enabling STAs to enable the DBE mode independent of the AP's mode, the STAs may reduce a signaling overhead associated with enabling the DBE mode at the STAs. By supporting semi-static or dynamic switching between the DBE mode being enabled and the DBE mode being disabled, the system may improve resource utilization and coordination between devices. For example, an AP may disable the DBE mode to improve frequency resource sharing with other APs in the system (e.g., during times with relatively high traffic for the other APs). The AP may enable the DBE mode to improve signal throughput for the AP and STAs associated with the AP (e.g., during times with relatively low traffic for the other APs).

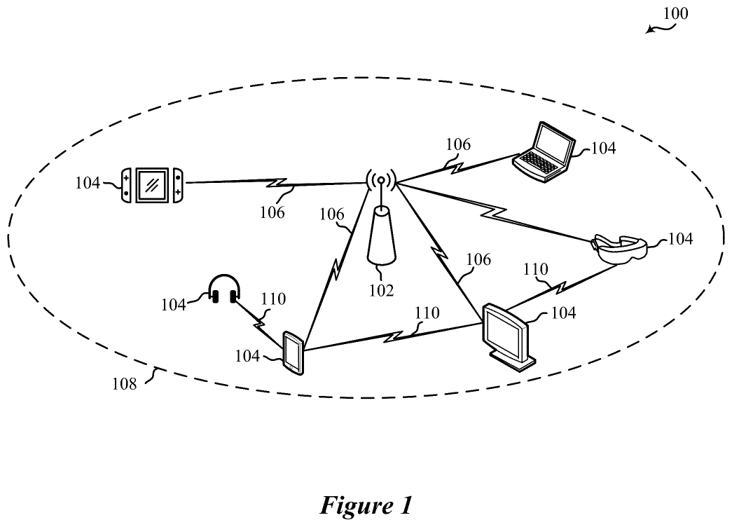

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically (e.g., in accordance with a periodicity) broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 gigahertz (GHz), 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz 52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise underutilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

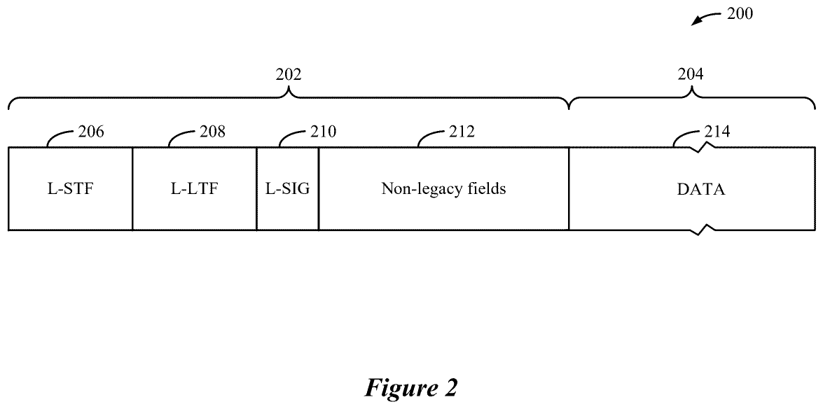

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

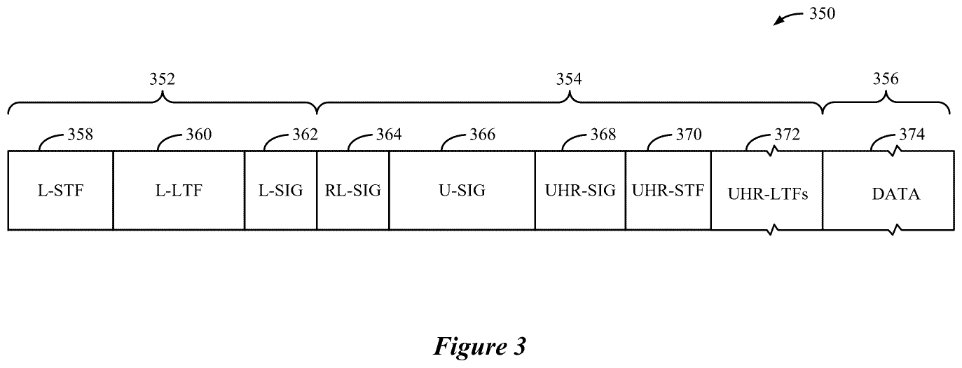

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

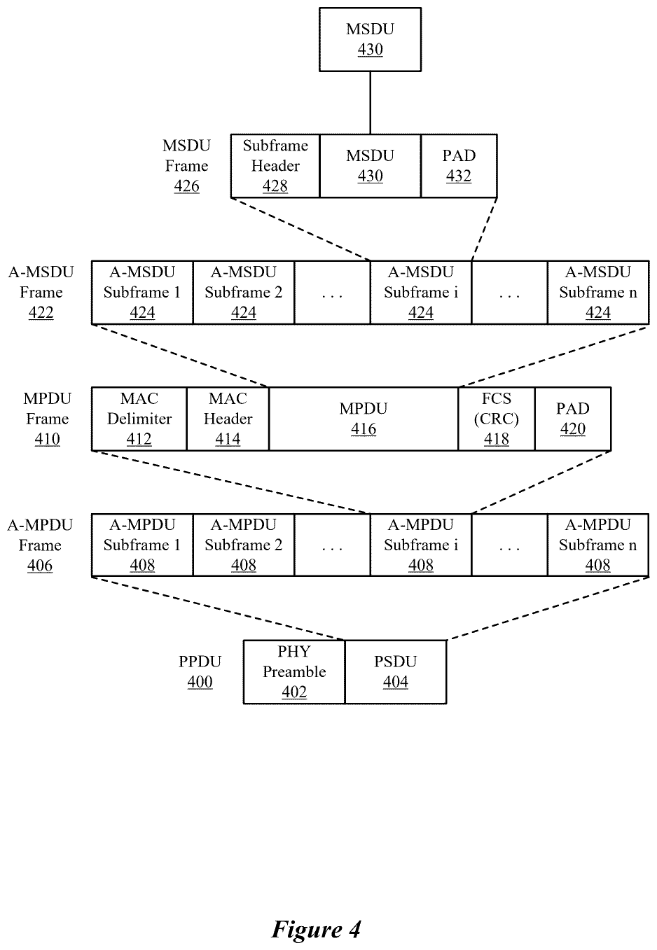

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a NAV, which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described herein.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is, in some aspects, a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the UHR-SIG field for a UHR PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of UHR-SIG can be used to individually allocate RUs to the single user, thereby avoiding the punctured channels. In some other examples, U-SIG may be used to indicate SU preamble puncturing. For example, the SU preamble puncturing may be indicated by a value of the UHR-SIG compression field in U-SIG.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

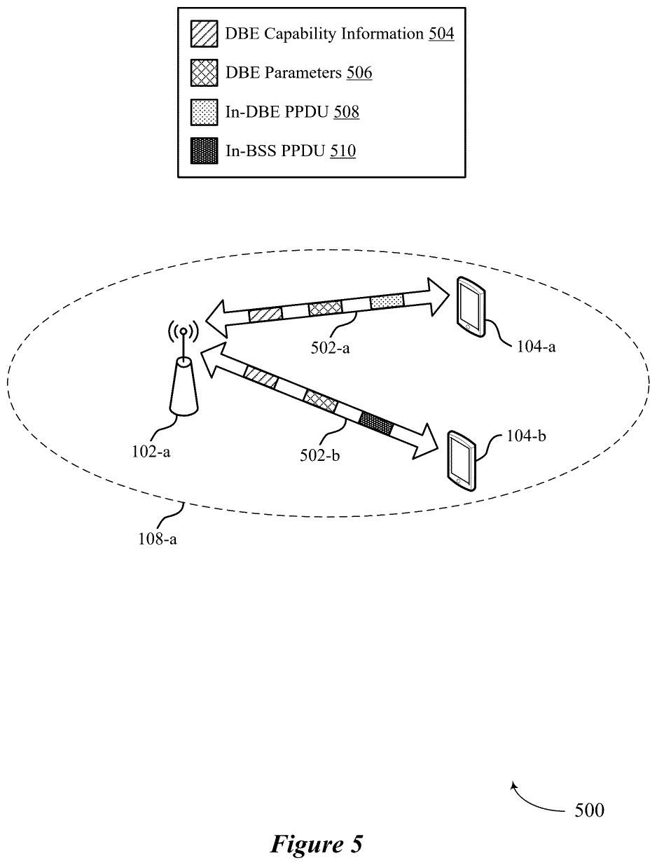

FIG. 5 shows an example of a signaling diagram 500 that supports signaling and operations for DBE. The signaling diagram 500 may include an AP 102-a (e.g., an AP STA) and one or more STAs (e.g., non-AP STAs), such as a STA 104-a and a STA 104-b. The AP 102-a may be an example of an AP 102 as described with reference to FIG. 1, and the STAs may be examples of STAs 104 as described with reference to FIG. 1. The AP 102-a may provide network coverage for a coverage area 108-a. The AP 102-a and the STA 104-a may communicate via a link 502-a (e.g., one or more first wireless links), and the AP 102-a and the STA 104-b may communicate via a link 502-b (e.g., one or more second wireless links). The AP 102-a and one or more STAs 104 may support a DBE feature. The DBE feature may enable the AP 102-a to expand its operating bandwidth to a bandwidth size greater than a BSS operating bandwidth for communications with one or more STAs 104. The expanded operating bandwidth may support improved throughput for communications.

In some examples, the AP 102-a may support a first operating bandwidth with a first bandwidth size. The first operating bandwidth—which, in some examples, may be referred to as a “regular” bandwidth—may be an example of a BSS operating bandwidth. The STA 104-a, the STA 104-b, or both may support communications via the BSS operating bandwidth. In some examples, the BSS operating bandwidth may span 80 MHz.

Additionally, the AP 102-a may support a second operating bandwidth with a second bandwidth size. The second bandwidth size may be different from the first bandwidth size. For example, the second operating bandwidth—which, in some examples, may be referred to as an “extended” bandwidth—may be an example of a DBE operating bandwidth. The bandwidth size of the DBE operating bandwidth may be relatively greater than the bandwidth size of the BSS operating bandwidth. In some examples, the DBE operating bandwidth may span 320 MHz. Additionally, or alternatively, the AP 102-a may support other operating bandwidth sizes (e.g., sizes smaller than the BSS operating bandwidth, sizes greater than the BSS operating bandwidth but less than the DBE operating bandwidth, or any combination thereof).

Some STAs 104 may support DBE, while other STAs 104 may not support DBE. For example, the STA 104-a may support DBE, while the STA 104-b may fail to support DBE. For example, the STA 104-b may be a legacy STA that supports BSS communications but not DBE communications.

DBE STAs (e.g., DBE AP STAs, DBE non-AP STAs, or both) may communicate DBE-specific parameters. In some examples, the DBE STAs may transmit indications of static parameters for DBE operation, dynamic parameters for DBE operation, or both. Static parameters for a DBE STA may remain unchanged during the lifetime of the DBE STA. For example, the static parameters may include DBE capability information 504 for the DBE STA. Dynamic parameters may change over time. The dynamic parameters may include DBE parameters 506 for the DBE STA.

In some examples, the DBE capability information 504 may indicate support for DBE. Additionally, or alternatively, the DBE capability information 504 may indicate a supported DBE bandwidth size capability (e.g., a threshold bandwidth size, such as a maximum bandwidth size supported for DBE). If a DBE STA enables a DBE mode, the DBE STA may expand its operating bandwidth up to the supported DBE bandwidth size capability advertised in the DBE capability information 504. For example, the DBE STA may advertise a supported DBE bandwidth size capability of 320 MHz, but the DBE STA may expand its operating bandwidth to 160 MHz in the DBE mode (e.g., the DBE STA may refrain from using the full DBE bandwidth size).

In some implementations, the DBE STA may transmit the DBE capability information 504 via a UHR capabilities element. In some examples, the AP 102-a may transmit a UHR capabilities element that indicates whether the AP 102-a supports a DBE mode, the DBE bandwidth size capability supported by the AP 102-a, or both. The AP 102-a may transmit the UHR capabilities element to multiple STAs 104. In some examples, the STA 104-a may transmit a UHR capabilities element that indicates whether the STA 104-a supports a DBE mode, the DBE bandwidth size capability supported by the STA 104-a, or both. In some examples, the STA 104-b may similarly transmit a UHR capabilities element indicating the DBE capability information 504 for the STA 104-b. DBE STAs may detect (e.g., determine or otherwise identify) other DBE STAs based on the DBE capability information 504. For example, the STA 10a-a may receive the DBE capability information 504 for the AP 102-a and may determine that the AP 102-a supports a DBE mode. Similarly, the AP 102-a may receive the DBE capability information 504 for the STA 104-a and may determine that the STA 104-a supports the DBE mode.

In some implementations, a DBE STA may transmit the DBE parameters 506 via an operation element (e.g., a UHR operation element), a parameters element (e.g., a UHR parameters element), a parameters update element (e.g., a UHR parameters update element), a critical update element (e.g., a UHR critical update element), or any combination thereof. The UHR operation element may indicate DBE parameters 506 currently used by the AP 102-a, such as whether the DBE mode is enabled, the DBE channel, the DBE bandwidth, or any combination thereof. In contrast, the UHR parameters element may indicate DBE parameters 506 to be used at a different time, such as a time in the future or past (e.g., or DBE parameters 506 requested for use at a different time, such as a time in the future). The AP 102-a or a STA 104 may transmit a UHR parameters element indicating the DBE parameters 506.

The DBE parameters 506 (e.g., dynamic DBE parameters) may include switching delay information, DBE channel information, DBE bandwidth information, DBE channel statistics, DBE channel load information, disabled subchannel information, or any combination of these or other DBE parameters. In some examples, different DBE STAs may indicate different DBE parameters 506. For example, the AP 102-a may indicate switching delay information specific to the AP 102-a, DBE channel information for the AP 102-a, DBE bandwidth information for the AP 102-a, DBE channel statistics, DBE channel load information, disabled subchannel information, or any combination thereof. The STA 104-a may indicate switching delay information specific to the STA 104-a, DBE channel information for the STA 104-a, DBE bandwidth information for the STA 104-a, or any combination thereof. If the STA 104-b supports DBE, the STA 104-b may indicate switching delay information specific to the STA 104-b, DBE channel information for the STA 104-b, DBE bandwidth information for the STA 104-b, or any combination thereof.

In a first example, the DBE parameters 506 may indicate one or more switching delays. A switching delay may indicate an amount of time (e.g., a threshold amount of time, a minimum amount of time) used by a DBE STA to perform an operating bandwidth switch. In some implementations, a DBE STA may indicate one switching delay for any switch between the first operating bandwidth (e.g., the BSS bandwidth) and the second operating bandwidth (e.g., the DBE bandwidth). In some other implementations, the DBE STA may indicate a first switching delay for switching from the first operating bandwidth to the second operating bandwidth and a second switching delay for switching from the second operating bandwidth to the first operating bandwidth. In some examples, the first switching delay may be referred to as a “switching” delay for DBE (e.g., switching to a DBE bandwidth), and the second switching delay may be referred to as a “switch back” delay for DBE (e.g., switching back to a BSS bandwidth). In yet some other implementations, the DBE STA may indicate per-bandwidth-pair delay values. For example, the DBE STA may indicate a set of switching delays, where each switching delay indicates an amount of time configured or allocated for the DBE STA to switch between a respective bandwidth pair (e.g., from a first bandwidth size to a second bandwidth size). In some examples, the set of switching delays may include a first switching delay for switching from an 80 MHz bandwidth to a 160 MHz bandwidth, a second switching delay for switching from the 80 MHz bandwidth to a 320 MHz bandwidth, a third switching delay for switching from the 160 MHz bandwidth to the 320 MHz bandwidth, a fourth switching delay for switching from the 160 MHz bandwidth to the 80 MHz bandwidth, a fifth switching delay for switching from the 320 MHz bandwidth to the 80 MHz bandwidth, a sixth switching delay for switching from the 320 MHz bandwidth to the 160 MHz bandwidth, or any combination of these switching delays or other switching delays supporting other bandwidth sizes.

In a second example, the DBE parameters 506 may indicate a DBE channel or DBE bandwidth to use in a DBE mode. For example, the DBE parameters 506 may include a channel number of the DBE channel (e.g., the channel at which DBE operation occurs). For example, the DBE parameters 506 may indicate a channel number associated with an expanded bandwidth size, such as 15, 47, 79, 111, 143, 175, or 207 associated with a 160 MHz bandwidth or 31, 95, 159, 63, 127, or 191 associated with a 320 MHz bandwidth. In some implementations, additional, or alternative, channel numbers associated with expanded bandwidth sizes may be supported (e.g., for other frequency bands or channelizations).

Additionally, or alternatively, the DBE parameters 506 may include a bandwidth size for the DBE channel. Because the DBE STA operates with a primary channel (e.g., a 20 MHz channel) for BSS operations, the bandwidth size may indicate the DBE channel as the operating bandwidth of the indicated bandwidth size that includes this primary channel. That is, the primary channel number and the bandwidth size for DBE may jointly indicate the DBE channel number. In some examples, different DBE STAs may support different DBE channels or DBE bandwidths. For example, the AP 102-a may indicate a 320 MHz DBE channel, while the STA 104-a may indicate a 160 MHz DBE channel (e.g., corresponding to a subband of the 320 MHz DBE channel indicated by the AP 102-a). If the AP 102-a and the STA 104-a both operate in the DBE mode, the AP 102-a and the STA 104-a may communicate an in-DBE PPDU 508 via the 160 MHz DBE channel (e.g., the smaller DBE channel supported by one of the DBE STAs).

In a third example, the DBE parameters 506 may indicate DBE channel statistics. For example, the AP 102-a may transmit an indication of one or more channel statistics associated with one or more operating bandwidths. In some examples, the AP 102-a may indicate an amount of time (e.g., a fraction of time, a percentage of time, a total amount of time, an average amount of time) that the AP 102-a operates on (e.g., communicates via) a specific bandwidth or according to a specific mode (e.g., BSS mode versus DBE mode, disabled DBE mode versus enabled DBE mode). For example, the AP 102-a may indicate the amount of time that the AP 102-a communicates via a BSS bandwidth, a first DBE bandwidth (e.g., with a 160 MHz bandwidth size), a second DBE bandwidth (e.g., with a 320 MHz bandwidth size), or some combination of these or other operating bandwidths.

A STA 104 (e.g., the STA 104-a) that receives the DBE channel statistics may select an AP 102 for association based on the DBE channel statistics. For example, if the STA 104-a detects multiple APs 102 during a scanning operation, the STA 104 may select to associate with the AP 102-a based on the AP 102-a operating via a DBE bandwidth relatively more often than other detected APs 102. The STA 104-a (e.g., a STA 104 that supports DBE operation) may improve its average throughput by associating with the AP 102-a that operates in the DBE mode relatively more frequently than the other APs 102.

In a fourth example, the DBE parameters 506 may indicate DBE channel load information. For example, the AP 102-a may transmit an indication of the load on a channel (e.g., where a “channel” may additionally, or alternatively, be referred to as a “subchannel”). The indicated load may be a quantity of STAs 104 operating via the channel (e.g., channel or subchannel), a quantity of signals communicated via the channel (e.g., channel or subchannel), or any other value or metric indicating channel usage. In some examples, the AP 102-a may indicate per-subchannel load information.

In a fifth example, the DBE parameters 506 may indicate one or more disabled subchannels, for example, using a disabled subchannel bitmap. In some implementations, the AP 102-a may signal an indication of a static puncturing pattern for the BSS bandwidth. For example, the AP 102-a may transmit an EHT operation element that includes a disabled subchannel bitmap indicating which, if any, subchannels of the BSS channel are disabled (e.g., punctured) for communication. For example, the disabled subchannel bitmap may include two octets of bits, where a subset of the bits corresponds to subchannels within the BSS channel. In some cases, the other bits may be reserved. For example, for an 80 MHz BSS operating bandwidth, the first four bits of the 16-bit bitmap may each correspond to a 20 MHz portion of the 80 MHz BSS operating bandwidth, and the remaining twelve bits may be reserved. A first bit value (e.g., a “0” value) may indicate that a corresponding subchannel (e.g., a 20 MHz subchannel) is enabled, while a second bit value (e.g., a “1” value) may indicate that the corresponding subchannel is disabled. A wireless device transmitting via the BSS operating bandwidth may puncture the signal, such that the signal is transmitted via the enabled subchannels of the BSS operating bandwidth but not the disabled subchannels of the BSS operating bandwidth.

In some examples, to indicate disabled (e.g., punctured) subchannels that are outside the BSS operating bandwidth, but within the DBE operating bandwidth, the AP 102-a may reuse the disabled subchannel bitmap for BSS to also apply for DBE. For example, the AP 102-a may use the remaining bits of the two octets to indicate disablement of respective subchannels within the DBE operating bandwidth. For example, each bit of the 16-bit bitmap may indicate whether a corresponding 20 MHz subchannel is disabled from a 320 MHz DBE operating bandwidth. A STA 104-a receiving the disabled subchannel bitmap may determine the disabled subchannels within the BSS operating bandwidth and within the DBE operating bandwidth based on the bit values of this one bitmap.

In some other examples, STAs 104 (e.g., legacy STAs or other STAs 104) may expect the reserved bits of the disabled subchannel bitmap for BSS to be set to “0” values. As such, the disabled subchannel bitmap for BSS may not support additionally indicating subchannel disablement for subchannels outside the BSS operating bandwidth. In some such examples, the AP 102-a may transmit a second disabled subchannel bitmap for DBE, for example, within the DBE operation parameters. The disabled subchannel bitmap for BSS (e.g., transmitted via the EHT operation element) may indicate a first puncturing pattern for the BSS operating bandwidth, while the disabled subchannel bitmap for DBE (e.g., transmitted via the DBE operation parameters) may indicate a second puncturing pattern for the DBE operating bandwidth. A STA 104-a that supports DBE and has a DBE mode enabled may use the disabled subchannel bitmap for DBE for determining subchannel puncturing for communications via the DBE operating bandwidth. In some implementations, the disabled subchannel bitmap for DBE may indicate the disabled subchannels for the full DBE operating bandwidth (e.g., including the subband corresponding to the BSS operating bandwidth). In some other implementations, the disabled subchannel bitmap for DBE may indicate the disabled subchannels for the incremental bandwidth from the BSS operating bandwidth to the DBE operating bandwidth (e.g., a subband of the DBE operating bandwidth that does not correspond to the BSS operating bandwidth), where the disabled subchannel bitmap for BSS indicates the subband of the DBE operating bandwidth that corresponds to the BSS operating bandwidth.

If the AP 102-a enables the DBE mode at the AP 102-a, the AP 102-a may flexibly communicate with STAs 104 via the DBE operating bandwidth or the BSS operating bandwidth. For example, if the STA 104-a has also enabled the DBE mode at the STA 104-a, the AP 102-a and the STA 104-a may communicate in-DBE PPDUs 508 via the DBE operating bandwidth (e.g., via at least a portion of the DBE operating bandwidth, such that an in-DBE PPDU 508 uses a set of frequency resources up to the DBE operating bandwidth). However, if the STA 104-b has not enabled the DBE mode (e.g., the STA 104-b does not support the DBE mode or has the DBE mode disabled), the AP 102-a and the STA 104-b may communicate in-BSS PPDUs 510 via the BSS operating bandwidth. Additionally, or alternatively, the AP 102-a may communicate with other STAs 104 via other operating bandwidths (e.g., other DBE or BSS operating bandwidths of different bandwidth sizes).

In some examples, if the AP 102-a and the STA 104-a have both enabled the DBE mode but operate with different DBE bandwidths, the AP 102-a and the STA 104-a may exchange frames using in-DBE PPDUs 508 that span frequency resources up to the smaller (e.g., a minimum) of the DBE operating bandwidths of the AP 102-a and the STA 104-a. For example, if the AP 102-a has enabled the DBE mode with a DBE operating bandwidth of 320 MHz and the STA 104-a has enabled the DBE mode with a DBE operating bandwidth of 160 MHz, the AP 102-a and the STA 104-a may exchange frames using in-DBE PPDUs 508 that span frequency resources up to 160 MHz bandwidth (e.g., the smaller of the two DBE operating bandwidths).

In some examples, DBE STAs may support other signaling that provides DBE information. For example, the AP 102-a may support a signal that recommends for a STA 104 (e.g., a DBE STA) to operate in the DBE mode. If the AP 102-a enables the DBE mode, but the STA 104-a has the DBE mode disabled, the AP 102-a may transmit a signal (e.g., a frame or message) to the STA 104-a that requests (e.g., recommends) the STA 104-a to enable the DBE mode. For example, the AP 102-a may transmit an action frame (e.g., a link reconfiguration request frame, a link reconfiguration notify frame, a UHR operating mode notification frame) that indicates the request to enable the DBE mode at the STA 104-a. In some examples, the action frame may further include one or more DBE parameters (e.g., requested parameters) for the DBE mode. The STA 104-a may receive the action frame and may determine whether or not to enable the DBE mode based on the request. In some implementations, the STA 104-a may accept the request and may enable the DBE mode based on the action frame. In some other implementations, the STA 104-a may reject (e.g., ignore) the request and continue operating with the DBE mode disabled at the STA 104-a.

Additionally, or alternatively, the AP 102-a may support polling STAs 104 for interest in enabling the DBE mode. In some systems, the AP 102-a may default to operating with the DBE mode disabled to reduce energy consumption at the AP 102-a (e.g., by using a relatively smaller bandwidth for communications). The AP 102-a may enable the DBE mode if one or more STAs 104 are interested in (e.g., request) enablement of the DBE mode. The AP 102-a may poll STAs 104 associated with the AP 102-a to determine whether the STAs 104 request that the AP 102-a enable the DBE mode. For example, the AP 102-a may transmit a frame that polls multiple STAs 104 for DBE information. The frame may be an example of an action frame (e.g., a link reconfiguration request frame, a link reconfiguration notify frame, a UHR operating mode notification frame), an aggregate control frame, a control frame exchange (e.g., with a buffer status report poll (BSRP) frame, a multi-user block acknowledgment (M-BA) frame, a null data packet (NDP) feedback report poll (NFRP) frame), or any other frame. A STA 104 receiving the frame may respond (e.g., with a corresponding response frame) that indicates whether the STA 104 requests enablement of the DBE mode at the AP 102-a. In some examples, STAs 104 that do not support DBE may not respond to the frame or may not receive the frame (e.g., the AP 102-a may transmit the frame to DBE STAs). If a quantity of STAs 104 requesting DBE enablement satisfies a threshold (e.g., a static or dynamic threshold at the AP 102-a), the AP 102-a may enable the DBE mode based on the poll results.

Additionally, or alternatively, the STA 104-a may request the AP 102-a to enable the DBE mode. In some examples, the STA 104-a may have a relatively large amount of data to send to the AP 102-a. Transmitting this data via the BSS operating bandwidth may cause increased congestion, power consumption, collisions, or some combination thereof for the system. However, the AP 102-a may continue operating with the DBE mode disabled. To improve throughput, the STA 104-a may transmit a frame that requests the AP 102-a (e.g., the associated AP for the STA 104-a) to enable the DBE mode at the AP 102-a. The frame may be an example of an action frame (e.g., a link reconfiguration request frame, a link reconfiguration notify frame, a UHR operating mode notification frame), an aggregate control frame, a control frame exchange (e.g., with a BSRP frame or an M-BA frame), or any other frame. In some examples, the STA 104-a may use the same frame (e.g., the same frame type, the same frame format) that enables the DBE mode at the STA 104-a to request enablement of the DBE mode at the AP 102-a. If the AP 102-a receives this frame while the AP 102-a has the DBE mode enabled, the AP 102-a may interpret the frame as a DBE enablement for the STA 104-a. In contrast, if the AP 102-a receives this frame while the AP 102-a has the DBE mode disabled, the AP 102-a may interpret the frame as request for the AP 102-a to enable the DBE mode. In some examples, the frame may additionally include one or more requested DBE parameters for the DBE mode.

In some examples, such signaling may support other modes beyond DBE. For example, the AP 102-a, the STA 104-a, or both may support signaling that requests or polls interest in dynamic subband operation (DSO) operation, non-primary channel access (NPCA) operation, or any other modes of operation.

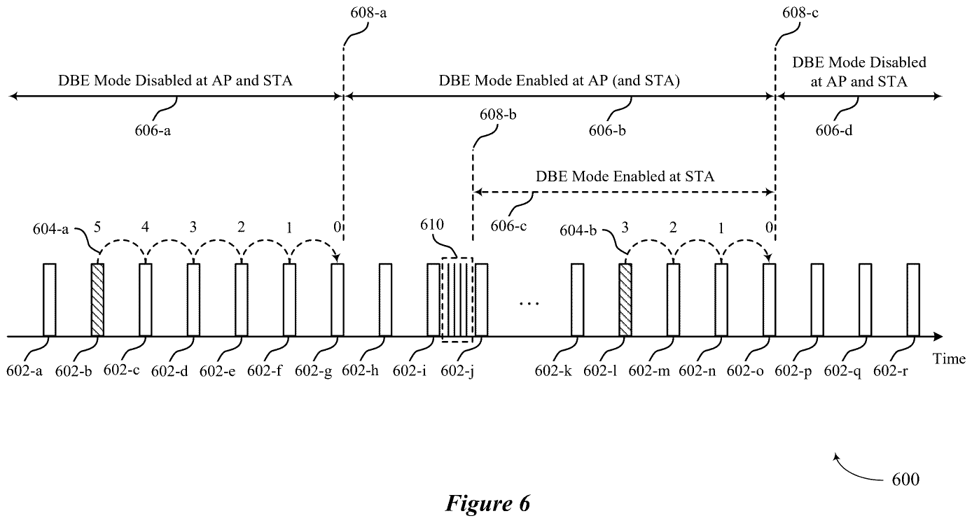

FIG. 6 shows an example timeline 600 that supports DBE enablement and disablement for a wireless AP and a wireless STA. An AP 102 (e.g., an AP STA) and a STA 104 (e.g., a non-AP STA), which may be examples of an AP 102 and a STA 104 as described with reference to FIG. 1-5, may communicate signals (e.g., frames) that enable and disable a DBE mode. The wireless devices may use a countdown mechanism to trigger DBE enablement, DBE disablement, or both.

In some examples, an AP 102 may semi-statically signal to switch between operating according to a BSS operating bandwidth and operating according to a DBE operating bandwidth. The AP 102 may advertise the switch between operating bandwidths using a countdown mechanism. The AP 102 may support periodic, or otherwise scheduled, TBTTs. In some examples, the TBTTs may occur at a regular interval referred to as a beacon interval, such as every 100 milliseconds (ms). At a TBTT, the AP 102 may transmit a beacon (e.g., a beacon frame) to one or more STAs 104. The beacon frame may be an example of a traffic indication map (TIM) beacon frame or a delivery traffic indication map (DTIM) beacon frame. The beacon frame may support discovery of the AP 102, provide network information to one or more STAs 104, or both.

The AP 102 may operate with the DBE mode disabled during a first time period 606-a. The first time period 606-a may include a TBTT 602-a, a TBTT 602-b, a TBTT 602-c, a TBTT 602-d, a TBTT 602-e, a TBTT 602-f, and a TBTT 602-g. In some examples, the AP 102 may transmit a signal (e.g., a beacon frame or other frame) at the TBTT 602-b that indicates enablement of the DBE mode at the AP 102. The signal may initiate a countdown mechanism 604-a for DBE mode enablement.

For example, the signal may include a UHR parameters element. The UHR parameters element may include an element identifier (ID) subfield, a length subfield, an element ID extension subfield, an operation parameters control subfield, an operation parameters information subfield, or any combination thereof. The operation parameters control subfield may indicate the presence or absence of fields within the operation parameters information subfield. The operation parameters information subfield may indicate parameters for one or more features, such as DBE operation, dynamic subband operation (DSO) operation, non-primary channel access (NPCA) operation, or any combination of these or other operations or modes. For example, the operation parameters information subfield may include one or more DBE operation parameters to support DBE mode enablement.

In some examples, to support the countdown mechanism 604-a, the operation parameters control subfield may include a TBTT count subfield. The TBTT count subfield may be present in the operation parameters control subfield if the AP 102 is transmitting a parameter update element (e.g., a UHR Parameters Update element). The UHR parameters element may indicate enablement of the DBE mode by setting a DBE operation enabled field value to 1, and the TBTT count subfield may indicate a time 608-a at which the AP 102 will operate using the DBE operating bandwidth for the DBE mode. In some examples, the time 608-a may be based on a switching delay for switching from a BSS operating bandwidth to a DBE operating bandwidth. For example, the TBTT count subfield may indicate a value of 5. This value may indicate that the AP 102 may support communications via the DBE operating bandwidth after five TBTTs. In some examples, the subsequent five TBTTs may include the TBTT count subfield, with the value in the TBTT count subfield decrementing for each TBTT. For example, the TBTT count subfield may indicate 4 for the beacon frame transmitted at the TBTT 602-c, the TBTT count subfield may indicate 3 for the beacon frame transmitted at the TBTT 602-d, the TBTT count subfield may indicate 2 for the beacon frame transmitted at the TBTT 602-e, the TBTT count subfield may indicate 1 for the beacon frame transmitted at the TBTT 602-f, and the TBTT count subfield may indicate 0 for the beacon frame transmitted at the TBTT 602-g. In some other examples, the subsequent five TBTTs may not include the TBTT count subfield, and instead wireless devices may use the countdown mechanism 604-a to track the countdown internally. Based on this countdown mechanism 604-a, STAs 104 receiving one or more of the beacon frames may determine the time at which the AP 102 enables the DBE mode and operates in accordance with the DBE operating bandwidth. For example, based on the TBTT count subfield indicating 0 for the beacon frame transmitted at the TBTT 602-g, the AP 102-a may switch to operating via the DBE operating bandwidth at (or after) the TBTT 602-g at time 608-a.

While the countdown is occurring (e.g., between the TBTT 602-b and the TBTT 602-g), the AP 102 may switch its operating bandwidth from a BSS operating bandwidth to a DBE operating bandwidth (e.g., silently, or otherwise transparently to STAs 104). In some examples, the AP 102 may perform such an operating bandwidth switch during an ongoing OBSS transmission. In some other examples, the AP 102 may transmit a clear to send to self (CTS2Self) signal to block STAs 104 from performing uplink transmissions while the AP 102 is performing the operating bandwidth switch. At the time 608-a, the STAs 104 that support DBE may determine that the AP 102 has completed the switch to the DBE operating bandwidth. During a second time period 606-b, the AP 102 may operate with the DBE mode enabled. The AP 102 may support communications via the DBE operating bandwidth (e.g., using 320 MHz PPDUs, or otherwise using an expanded bandwidth).

A STA 104 that supports DBE may similarly enable the DBE mode at the STA 104. In some examples, during the first time period 606-a, the STA 104 may operate with the DBE mode disabled. The STA 104 may receive the signal from the AP 102 at the TBTT 602-b and may determine that the AP 102 will enable the DBE mode at the time 608-a. In some examples, the STA 104 may perform an action frame exchange 610 with the AP 102 to enable the DBE mode at the STA 104. In some implementations, the STA 104 may enable the DBE mode after the DBE mode is enabled at the AP 102. For example, the STA 104 may enable the DBE mode at a time 608-b and may operate with the DBE mode enabled during a third time period 606-c. In some other implementations, the STA 104 may enable the DBE mode before the DBE mode is enabled at the AP 102 and the STA 104 may operate with the DBE mode enabled during the second time period 606-b.

The AP 102 operating with the DBE mode enabled during the second time period 606-b may communicate with STAs operating with the DBE mode enabled via the DBE operating bandwidth, STAs operating without the DBE mode enabled via the BSS operating bandwidth, or both. For example, the AP 102 and a STA 104 with the DBE mode enabled may exchange frames via the DBE operating bandwidth during the second time period 606-b. The AP 102 and a STA 104 without the DBE mode enabled (e.g., a legacy or non-DBE STA, or a DBE STA with the DBE mode disabled) may exchange frames via the BSS operating bandwidth during the second time period 606-b. The AP 102 may remain with the DBE mode enabled for multiple TBTTs (e.g., for a TBTT 602-h, a TBTT 602-i, a TBTT 602-j, a TBTT 602-k, a TBTT 602-l, a TBTT 602-m, a TBTT 602-n, and a TBTT 602-o). In some examples, the AP 102 may operate with the DBE mode enabled for a relatively long time period (e.g., on the scale of minutes or hours).

The AP 102 may disable the DBE mode using a similar technique as for DBE mode enablement. For example, the AP 102 may transmit a signal (e.g., with a UHR parameters update element) at a TBTT 602-l that indicates to disable the DBE mode. The signal may indicate a time 608-c at which to disable the DBE mode. In some examples, the signal may use a countdown mechanism 604-b to indicate the time 608-c. The quantity of TBTTs to count down may be the same or different for enablement and disablement. For example, the signal may indicate a TBTT count value of 3 to disable the DBE mode. The AP 102 may continue operating via the DBE operating bandwidth during the count down. At the indicated time 608-c, the AP 102 may disable the DBE mode at the AP 102, and the associated STAs 104 with the DBE mode enabled may be automatically switched to the BSS operating bandwidth. In some implementations, the AP 102 may determine (e.g., assume) that the STAs 104 have disabled the DBE mode at the time 608-c. If the AP 102 re-enables the DBE mode, the STAs 104 may re-enable the DBE mode by performing another action frame exchange 610. In some other implementations, the AP 102 may determine (e.g., assume) that the STAs 104 remain with the DBE mode enabled after the time 608-c. If the AP 102 re-enables the DBE mode, the AP 102 may determine these STAs 104 remain with the DBE mode enabled and may communicate via the DBE operating bandwidth without performing another action frame exchange 610.

In some examples, the AP 102 may switch its operating bandwidth from the DBE operating bandwidth to the BSS operating bandwidth after the time 608-c. This switch may span multiple TBTTs, such as a TBTT 602-p, a TBTT 602-q, and a TBTT 602-r. The AP 102 may perform the operating bandwidth switch transparent to the STAs 104 (e.g., during an ongoing OBSS transmission or using a CTS2Self signal to block uplink transmissions during the switch). The AP 102 and the STAs 104 may operate with the DBE mode disabled during a fourth time period 606-d. For example, the AP 102 and the STAs 104 may exchange frames via the BSS operating bandwidth.

In some examples, the DBE mechanism may not use the concept of “enable” or “disable” for the DBE mode. Instead, the AP 102 may advertise changes to its operating bandwidth (e.g., a change from 80 MHz to 160 MHz, or a change from 80 MHz to 320 MHz, or a change from 320 MHz to 160 MHz) by counting down a quantity of beacon frames until a change takes effect. In some such examples, STAs 104 that support DBE can implicitly determine that DBE is enabled based on the advertised bandwidth. Unlike other mechanisms, an action frame exchange initiated by the STA 104 may not signal a change of a DBE mode. Instead, a STA 104 may use an action frame exchange to signal a willingness (e.g., an interest, a request) of the STA 104 to participate in the DBE (such as exchange DBE PPDUs) using one or more parameters indicated in the action frame (such as a parameter indicating a bandwidth that the STA 104 can operate in). The signaling to indicate the willingness to participate in DBE may occur any time and may be independent of changes advertised by the AP 102. For example, the STA 104 may signal such an indication while the AP 102 is not operating via a DBE bandwidth but is operating via a BSS bandwidth. Thus, the STA 104 may indicate its willingness to participate in DBE operations at any time, regardless of whether the AP 102 operates via a DBE bandwidth or a non-DBE (e.g., BSS) bandwidth. Moreover, in some implementations, the indication of a willingness to participate in DBE operations may not imply that the STA 104 is ready to participate in DBE communications. The STA 104 may operate via the DBE bandwidth (e.g., indicated by the STA 104 in the latest action frame exchange) when the AP 102 also operates via the DBE bandwidth. If there is a difference in the DBE bandwidths of the STA 104 and the AP 102, the relatively smaller DBE bandwidth of the two DBE bandwidths may apply for DBE communications between the STA 104 and the AP 102. Thus, if the STA 104 indicates its willingness to participate in DBE communications in 160 MHz PPDUs and the AP 102 is operating in 320 MHz, the pair of wireless devices may exchange frames using 160 MHz PPDUs.

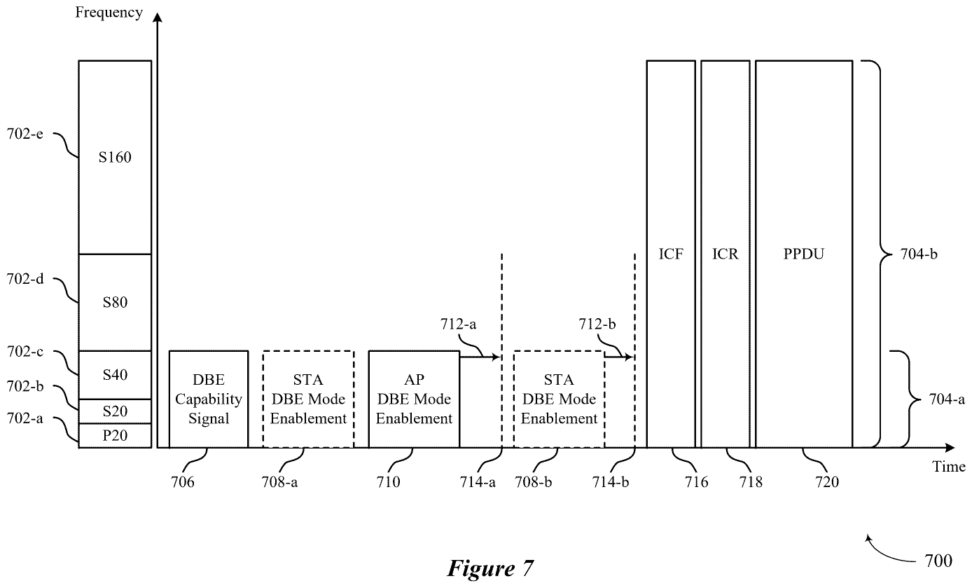

FIG. 7 shows an example timeline 700 of frame exchanges that supports a DBE mode. An AP 102 (e.g., an AP STA) and a STA 104 (e.g., a non-AP STA), which may be examples of an AP 102 and a STA 104 as described with reference to FIG. 1-6, may exchange frames that enable the DBE mode.

The AP 102 may support a set of channels in a frequency band. For example, the AP 102 may support a primary 20 MHz (P20) subchannel 702-a, a secondary 20 MHz (S20) subchannel 702-b, a secondary 40 MHz (S40) subchannel 702-c, a secondary 80 MHz (S80) subchannel 702-d, and a secondary 160 MHz (S160) subchannel 702-e. In some examples, the AP 102 may support communications via a BSS operating bandwidth 704-a that spans the P20 subchannel 702-a, the S20 subchannel 702-b, and the S40 subchannel 702-c (e.g., spanning a total bandwidth of 80 MHz). In some other examples, the BSS operating bandwidth 704-a may span a different set of subchannels, a different bandwidth size, or both. Additionally, in some examples, the AP 102 may support communications via a DBE operating bandwidth 704-b that spans the P20 subchannel 702-a, the S20 subchannel 702-b, the S40 subchannel 702-c, the S80 subchannel 702-d, and the S160 subchannel 702-e (e.g., spanning a total bandwidth of 320 MHz). In some other examples, the DBE operating bandwidth 704-b may span a different set of subchannels, a different bandwidth size, or both.

The AP 102 may operate with the DBE mode disabled (e.g., with a BSS mode enabled). While the DBE mode is disabled, the AP 102 may communicate with STAs 104 via the BSS operating bandwidth 704-a. The AP 102 may transmit, via the BSS operating bandwidth 704-a, a DBE capability signal 706 indicating that the AP 102 supports the DBE mode. In some examples, one or more STAs 104 may similarly transmit DBE capability signals 706 indicating whether the one or more STAs 104 support the DBE mode. The DBE capability signal 706 may be an example of a frame (e.g., a control frame, a management frame, a beacon frame, a data frame) that includes an element (e.g., a UHR capabilities element) indicating supports for the DBE mode, a supported DBE bandwidth size, or both.

In some examples, a STA 104 that supports the DBE mode (e.g., a DBE STA, a DBE-capable STA) may enable the DBE mode at the STA 104 regardless of whether the AP 102 has the DBE mode enabled. For example, the STA 104 may transmit an action frame 708-a that enables the DBE mode at the STA 104. In some implementations, the STA 104 may enable the DBE mode while the AP 102 is operating with the DBE mode disabled. In such implementations, the STA 104 and the AP 102 may remain communicating via the BSS operating bandwidth 704-a until the AP 102 also enables the DBE mode.

The AP 102 may transmit a frame 710 that enables the DBE mode at the AP 102. The frame 710 may indicate a time 714-a (e.g., a timing synchronization function (TSF) value, a TBTT, or some other indication of time) at which the AP 102 will complete the switch to the DBE mode (e.g., the switch to the DBE operating bandwidth 704-b). In some examples, the frame 710 may indicate the time 714-a using a countdown mechanism 712-a, such as a TBTT count value. The STA 104 may receive the frame 710 and may determine the time 714-a at which the AP 102 will have the DBE mode enabled.

If the STA 104 is already operating with the DBE mode enabled, in some examples, the STA 104 and the AP 102 may communicate via the DBE operating bandwidth 704-b at the time 714-a (e.g., once the AP 102 has enabled the DBE mode). For example, the AP 102 may determine that the STA 104 is capable of communicating via the DBE operating bandwidth 704-b at the time 714-a. However, in some other examples, the STA 104 may continue operating via the BSS operating bandwidth 704-a despite the STA 104 enabling the DBE mode (e.g., the save power). The STA 104 may instead switch to the DBE operating bandwidth 704-b after the AP 102 enables the DBE mode. This switch from the BSS operating bandwidth 704-a to the DBE operating bandwidth 704-b may involve a finite time (e.g., a switching delay, such as a switching delay indicated as a DBE parameter). In some such cases, the AP 102 may use the switching delay to determine when to communicate with the STA 104 via the DBE operating bandwidth 704-b. For example, after the time 714-a, the AP 102 may refrain from transmitting to the STA 104 until the switching delay has elapsed. For example, the AP 102 may start a timer at the time 714-a, where the timer has a duration of the switching delay. At expiry of the timer, the AP 102 and the STA 104 may communicate via the DBE operating bandwidth 704-b.

In some implementations, the AP 102 may determine (e.g., assume) that the STA 104 remains in the DBE mode between successive switches between the DBE operating bandwidth 704-b and the BSS operating bandwidth 704-a at the AP 102. Supporting DBE mode enablement at the STA 104 regardless of the AP's mode may reduce a signaling overhead associated with the STA 104 enabling the DBE mode, especially if the AP 102 transitions between enabled and disabled DBE mode relatively frequently (e.g., on the scale of seconds or minutes, as opposed to hours). For example, the STA 104 may refrain from performing an action frame exchange each time the AP 102 enables the DBE mode in order for the STA 104 to also enable the DBE mode. The STA 104 and the AP 102 may also improve the latency involved in the STA 104 enabling the DBE mode and improving throughput by using the DBE operating bandwidth 704-b for communications.

In some examples, a STA 104 that supports the DBE mode (e.g., a DBE STA, a DBE-capable STA) may enable the DBE mode after the AP 102 has the DBE mode enabled (e.g., after the DBE operating bandwidth 704-b has taken effect at the AP 102). For example, the STA 104 may transmit an action frame 708-b that enables the DBE mode at the STA 104 after the AP 102 is operating with the DBE mode enabled. In some examples, the action frame 708-b may indicate a time 714-b at which the STA 104 will have the DBE mode enabled (e.g., will operate according to the DBE operating bandwidth 704-b). The action frame 708-b may indicate the time 714-b based on a countdown mechanism 712-b. The STA 104 and the AP 102 may communicate via the DBE operating bandwidth 704-b at the time 714-b (e.g., once the STA 104 has enabled the DBE mode).

In some examples, a STA 104 may support either enabling the DBE mode after the AP 102 has the DBE mode enabled (e.g., a first enablement process) or enabling the DBE mode regardless of the AP's currently active mode (e.g., a second enablement process). The STA 104 or the AP 102 may signal an indication of whether the STA 104 may enable the DBE mode according to the first enablement process or the second enablement process.

In some examples, enabling the DBE mode at the STA 104 may involve an action frame exchange between the STA 104 and the AP 102. The action frame exchange may be an example of a two-way action frame exchange (e.g., request and response), a three-way action frame exchange (e.g., request, response, and acknowledgment), or a four-way action frame exchange (e.g., request, response, first acknowledgment, and second acknowledgment) between the STA 104 and the AP 102.

The STA 104 may transmit the action frame (e.g., the action frame 708-a or the action frame 708-b) as a request frame. The action frame may include a UHR parameters element that indicates which mode(s) are requested to be enabled by the STA 104, such as the DBE mode. Additionally, the UHR parameters element may indicate one or more parameters for the requested mode(s). For example, the STA 104 may include one or more requested DBE parameters in the frame that enables the DBE mode at the STA 104. The DBE parameters may include one or more switching delays, a DBE channel that the STA 104 requests to use, a DBE bandwidth size that the STA 104 requests to use, or any combination thereof. For example, the AP 102 may support a BSS operating bandwidth 704-a spanning 80 MHz and a DBE operating bandwidth 704-b spanning 320 MHz. However, a first STA 104 may transmit an action frame that enables the DBE mode at the first STA 104 and requests a DBE bandwidth spanning 160 MHz, while a second STA 104 may transmit an action frame that enables the DBE mode at the second STA 104 and requests a DBE bandwidth spanning 320 MHz. While operating with the DBE mode enabled, the AP 102 may exchange frames with the first STA 104 via an operating bandwidth spanning up to 160 MHz and may exchange frames with the second STA 104 via an operating bandwidth spanning up to 320 MHz.

The STA 104 may transmit the action frame via an enabled link between the STA 104 (e.g., a non-AP STA or non-AP MLD) and the AP 102 (e.g., an AP STA or AP MLD). In some implementations, the STA 104 may enable the DBE mode for a first link using an action frame transmitted via a second link. For example, the STA 104 may enable the DBE mode for link 0 (e.g., corresponding to the 6 GHz frequency band) using an action frame transmitted via link 1 (e.g., corresponding to the 2.4 GHz frequency band). To support such flexibility, the action frame may indicate for which link the action frame applies. For example, the action frame may indicate DBE enablement, one or more DBE parameters, and a link (e.g., link ID) for the DBE enablement and the one or more DBE parameters.

The AP 102 may transmit a response action frame based on the action frame received from the STA 104. The response action frame may accept or reject the enablement of the DBE mode at the STA 104. Additionally, or alternatively, the response action frame may accept or modify the requested DBE parameters. In some examples, the AP 102 may transmit the response action frame when the AP 102 is ready to serve the STA 104 in the DBE mode. Additionally, or alternatively, the AP 102 may respond to the action frame within a timeout interval. The timeout interval may be specific to the requested mode (e.g., specific to DBE enablement). If multiple modes are being updated (e.g., enabled or disabled), the timeout interval may correspond to the greatest of the timeout intervals specific to the multiple modes.

In some examples, the STA 104 may transmit an acknowledgment to the action response frame. Additionally, in some examples, the AP 102 may transmit a second acknowledgment in response to the STA's acknowledgment. The STA 104 may enable the DBE mode and requested DBE parameters based on receiving the response action frame, based on transmitting the acknowledgment, based on receiving the second acknowledgment, or based on expiry of a timeout interval.

In some examples, the action frame may be an example of a link reconfiguration request frame. The link reconfiguration request frame may include a reconfiguration multi-link element that indicates to enable the DBE mode, one or more DBE parameters, or both. The per-STA profile of the reconfiguration multi-link element may include a link ID that indicates the link for which to apply the DBE mode enablement, the one or more DBE parameters, or both. In such examples, the action response frame may be an example of a link reconfiguration notify frame or a link reconfiguration response frame.

In some other examples, the action frame may be an example of a UHR operating mode notification frame. The UHR operating mode notification frame may include a multi-link operation (MLO) link information element that includes a link ID bitmap. The link ID bitmap may indicate the link for which to apply the DBE mode enablement, the one or more DBE parameters, or both. In such other examples, the action response frame may also be an example of a UHR operating mode notification frame.

Once the AP 102 and the STA 104 are both operating with the DBE mode enabled, the AP 102 and the STA 104 may communicate frames via the DBE operating bandwidth 704-b. In some examples, the AP 102 and the STA 104 may precede frame exchanges via the DBE operating bandwidth 704-b with an exchange of an initial control frame (ICF) 716 and an initial control response (ICR) 718. For example, the AP 102 and the STA 104 may exchange a request to send (RTS) frame and a clear to send (CTS) frame according to a non-HT duplicate PPDU format. Other examples of ICFs 716 may include a multi-user RTS (MU-RTS), a BSRP trigger frame, a BSRP trigger frame that solicits a non-HT or non-TB response, or any other ICF 716. Using the ICF 716 and the ICR 718 for the DBE mode may, in some examples, override other rules for other enabled modes (e.g., regardless of whether another enabled mode uses an ICF/ICR exchange). The exchange of the ICF 716 and the ICR 718 may enable OBSS STAs that operate with a primary channel different from the BSS primary channel to set a NAV and backoff from the DBE operating bandwidth 704-b, mitigating possible negative effects of hidden nodes. After the exchange of the ICF 716 and the ICR 718, the AP 102 and the STA 104 may communicate a PPDU 720 via the DBE operating bandwidth 704-b. In some examples, the AP 102 and the STA 104 may communicate a data frame, a management frame, a control frame, or any combination thereof via the DBE operating bandwidth 704-b.

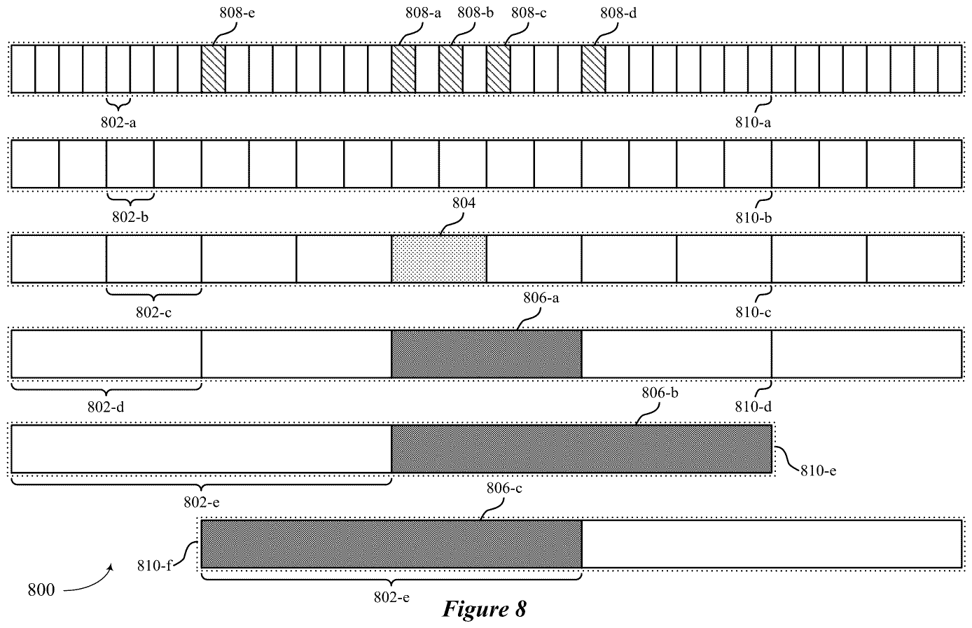

FIG. 8 shows an example of a channelization 800 that supports a DBE mode. The channelization 800 may support the DBE mode at an AP 102, a STA 104, or both as described with reference to FIG. 1-7. The channelization 800 may support, or otherwise configure, channels of different channel widths (e.g., different bandwidth sizes). For example, the channelization 800 may include a first set of channels 810-a that each span a first bandwidth size 802-a (e.g., 20 MHz), a second set of channels 810-b that each span a second bandwidth size 802-b (e.g., 40 MHz), a third set of channels 810-c that each span a third bandwidth size 802-c (e.g., 80 MHz), a fourth set of channels 810-d that each span a fourth bandwidth size 802-d (e.g., 160 MHz), and a fifth set of channels 810-e that each span a fifth bandwidth size 802-e (e.g., 320 MHz). In some examples, the channelization 800 may support multiple sets of channels that span 320 MHz. For example, the channelization 800 may include a sixth set of channels 810-f that also each span the fifth bandwidth size 802-e(e.g., 320 MHz). The fifth set of channels 810-e and the sixth set of channels 810-f may be offset in the frequency domain (e.g., by 180 MHz). The channelization 800 may correspond to the 6 GHz frequency band or may correspond to any other supported frequency band. An AP 102 or STA 104 operating in a DBE mode may communicate via an expanded bandwidth, such as a channel with the fourth bandwidth size 802-d (e.g., 160 MHz) or the fifth bandwidth size 802-e (e.g., 320 MHz).

In some examples, a DBE STA (e.g., an AP 102 or STA 104) may operate according to a disabled DBE mode (e.g., an enabled BSS mode). The DBE STA may communicate via a first operating bandwidth with a first bandwidth size, such as a first BSS channel 804 with the third bandwidth size 802-c (e.g., 80 MHz). The DBE STA may use a first primary channel 808-a as the primary channel for the first BSS channel 804. The DBE STA may use the first primary channel 808-a to contend for access for the first BSS channel 804. For example, access to the first BSS channel 804 spanning 80 MHz may depend on a successful contention procedure via the first primary channel 808-a spanning 20 MHz (e.g., a subband of the 80 MHz channel).

The DBE STA may transmit a signal that enables the DBE mode. The DBE STA may include, in the signal or in a different signal indicating one or more DBE parameters, an indication of a DBE channel to use for the DBE mode. In some examples, the DBE STA may indicate the DBE channel using a channel number. For example, the DBE STA may indicate a first channel number (e.g., 79) corresponding to a first DBE channel 806-a with the fourth bandwidth size 802-d (e.g., 160 MHz). Alternatively, the DBE STA may indicate a second channel number (e.g., 95) corresponding to a second DBE channel 806-b with the fifth bandwidth size 802-e (e.g., 320 MHz) or a third channel number (e.g., 63) corresponding to a third DBE channel 806-c with the fifth bandwidth size 802-e. Accordingly, the DBE STA may indicate a specific DBE channel (e.g., a specific operating bandwidth) using the channel number.

In some other examples, the DBE STA may indicate the DBE channel using a channel bandwidth. The channel bandwidth, in combination with the DBE STA's primary channel, may indicate a specific DBE channel (e.g., a specific operating bandwidth). For example, the DBE STA may indicate the fourth bandwidth size 802-d. This bandwidth size may implicitly indicate the first DBE channel 806-a based on the first DBE channel 806-a spanning the indicated fourth bandwidth size 802-d and including the first primary channel 808-a for the DBE STA. That is, the indicated bandwidth size may uniquely indicate a DBE channel of the fourth set of channels 810-d based on each 20 MHz channel (e.g., each primary channel) overlapping with a single channel of the indicated bandwidth size. However, in some implementations, a 20 MHz channel (e.g., a primary channel) may overlap with multiple channels with a channel width of 320 MHz, for example, if the channelization 800 includes both the fifth set of channels 810-e that each span the fifth bandwidth size 802-e and the sixth set of channels 810-f that each span the fifth bandwidth size 802-e. For example, the first primary channel 808-a for the DBE STA may overlap in the frequency domain with both the second DBE channel 806-b and the third DBE channel 806-c. In some such implementations, the DBE STA may use different bandwidth values to differentiate between the fifth set of channels 810-e and the sixth set of channels 810-f.For example, a first bandwidth size value 320-1 may correspond to the fifth set of channels 810-e, and a second bandwidth size value 320-2 may correspond to the sixth set of channels 810-f. If the DBE STA indicates a bandwidth size 320-1, this bandwidth size may implicitly indicate the second DBE channel 806-b based on the second DBE channel 806-b corresponding to the first set of channels (e.g., the fifth set of channels 810-e) that span the indicated bandwidth size of 320 MHz and including the first primary channel 808-a for the DBE STA. Alternatively, if the DBE STA indicates a bandwidth size 320-2, this bandwidth size may implicitly indicate the third DBE channel 806-c based on the third DBE channel 806-c corresponding to the second set of channels (e.g., the sixth set of channels 810-f) that span the indicated bandwidth size of 320 MHz and including the first primary channel 808-a for the DBE STA.

In some examples, a DBE STA may use one or more other modes of operation, for example, in addition to the DBE mode. The DBE STA may support coordination between multiple modes, for example, if the DBE STA operates with multiple modes enabled. In some implementations, multiple modes may improve spectral utilization for Wi-Fi communications. For example, the DBE mode may improve an operating bandwidth size for the DBE STA to improve utilization of frequency resources by the DBE STA. A DSO mode may support dynamically switching a narrowband STA 104 to use a secondary subchannel (e.g., “DSO” subchannel) to more efficiently utilize a full operating bandwidth of an AP 102. An NPCA mode may support switching a primary channel for a STA 104 to a different channel (e.g., an NPCA primary channel) to improve coordination between devices (e.g., mitigate negative effects of OBSS traffic detected on the primary channel). DBE STAs may further improve resource utilization by combining one or more such modes. For example, a DBE STA operating according to the DBE mode and the DSO mode may use a DSO subchannel outside the BSS operating bandwidth (e.g., but within the DSO operating bandwidth). Similarly, a DBE STA operating according to the DBE mode and the NPCA mode may use an NPCA primary channel outside the BSS operating bandwidth (e.g., but within the DSO operating bandwidth).

DBE STAs (e.g., APs 102 and STAs 104) may utilize one or more techniques to support interaction between the DBE mode and the NPCA mode. For example, the NPCA mode may enable an AP 102 to indicate a new 20 MHz channel as an NPCA primary channel within the AP's operating bandwidth. One or more NPCA STAs (e.g., AP STAs, non-AP STAs) may switch to using the NPCA primary channel as a primary channel if the NPCA STAs detect that the primary channel (e.g., the BSS primary channel, such as the first primary channel 808-a) is busy (e.g., due to OBSS traffic).

The location of the NPCA primary channel within the AP's operating bandwidth may affect the NPCA performance. For example, if the NPCA primary channel is located within a first half of the AP's operating bandwidth, the NPCA primary channel may overlap with communications using a subband of the AP's operating bandwidth (e.g., BSS communications via the first BSS channel 804). In contrast, if the NPCA primary channel is located within a secondary half of the AP's operating bandwidth, the NPCA primary channel may avoid such communications, improving the resource utilization and reducing congestion on the NPCA primary channel. The secondary half of the AP's operating bandwidth may change when the AP 102 enables the DBE mode.

For example, if the AP 102 is operating in a BSS mode (e.g., with the DBE mode disabled), the AP 102 may use a first NPCA primary channel 808-b that is located within a secondary half (e.g., the S40 subband) of the first BSS channel 804. If the AP 102 enables the DBE mode and switches to the first DBE channel 806-a with the fourth bandwidth size 802-d (e.g., 160 MHz), this first NPCA primary channel 808-b may now be located within a first half of the AP's operating bandwidth and may overlap with BSS communications via the first BSS channel 804. To improve NPCA performance, the AP 102 may switch from using the first NPCA primary channel 808-b to a second NPCA primary channel 808-c that is located within a secondary half (e.g., the S80 subband) of the first DBE channel 806-a. Similarly, if the AP 102 switches to the second DBE channel 806-b with the fifth bandwidth size 802-e (e.g., 320 MHz), the AP 102 may switch to using a third NPCA primary channel 808-d that is located within a secondary half (e.g., the S160 subband) of the second DBE channel 806-b (e.g., to avoid BSS communications and DBE communications via the first DBE channel 806-a). If the AP 102 switches to the third DBE channel 806-c with the fifth bandwidth size 802-e (e.g., 320 MHz), the AP 102 may switch to using a fourth NPCA primary channel 808-e that is located within a secondary half (e.g., the S160 subband) of the third DBE channel 806-c (e.g., to avoid BSS communications and DBE communications via the first DBE channel 806-a). The AP 102 may announce the channel switch for the NPCA primary channel with the announcement of DBE mode enablement (e.g., using a countdown mechanism in a beacon frame). For example, the AP 102 may transmit a frame that includes an operation parameters control element that indicates to enable the DSO mode and maintain the NPCA mode as enabled. The frame may further include an operation parameters information element that includes an NPCA primary channel element indicating an updated NPCA primary channel number to trigger the switch to the new NPCA primary channel (e.g., corresponding to the updated NPCA primary channel number).

An NPCA STA (e.g., an AP 102, a STA 104) operating with the NPCA mode enabled may use a finite amount of time to switch between the BSS primary channel (e.g., the first primary channel 808-a) and an NPCA primary channel (e.g., if an OBSS transmission is detected). This finite amount of time may be referred to as an NPCA switching delay. In some examples, switching from the BSS primary channel to the NPCA primary channel may use an NPCA “switching” delay, and switching from the NPCA primary channel to the BSS primary channel may use an NPCA “switch back” delay. The NPCA STA may signal an indication of such delays to other wireless devices to account for the delays. In some examples, an NPCA switching delay may depend on whether the NPCA primary channel is within the NPCA STA's operating bandwidth (e.g., the operating bandwidth of a STA 104). For example, when an AP 102 enables the DBE mode and updates an NPCA primary channel, in some implementations, the updated NPCA primary channel may move from inside a STA's operating bandwidth to outside the STA's operating bandwidth. For example, if a STA 104 has the NPCA mode enabled but not the DBE mode, the second NPCA primary channel 808-c that is located within the secondary half (e.g., the S80 subband) of the first DBE channel 806-a may be outside the operating bandwidth (e.g., the first BSS channel 804) of the STA 104. Accordingly, the AP 102 switching from the first NPCA primary channel 808-b to the second NPCA primary channel 808-c, the third NPCA primary channel 808-d, or the fourth NPCA primary channel 808-e may change the NPCA switching delay for some STAs 104 (e.g., STAs 104 with DBE disabled). That is, a change to the DBE mode status (e.g., from disabled to enabled, from enabled to disabled) at the AP 102 may trigger an update to one or more NPCA parameters for one or more STAs 104, such as STAs 104 operating within the first BSS channel 804.

In some examples, a STA 104 may update one or more NPCA parameters, such as one or more NPCA switching delay values, by performing an action frame exchange with the AP 102. The action frame exchange may update the one or more NPCA switching delay values based on the AP 102 enabling the DBE mode and the STA 104 not enabling the DBE mode (e.g., if the STA 104 does not support DBE).

In some other examples, a STA 104 may indicate two sets of switching delay values, where a first set applies to an NPCA primary channel that is within an operating bandwidth of the STA 104, and a second set applies to an NPCA primary channel that is outside the operating bandwidth of the STA 104. The STA 104 may transmit a frame indicating both sets of switching delay values to the AP 102, and the AP 102 may select which set of switching delay values to use based on whether the DBE mode is enabled at the AP 102 (e.g., whether the NPCA primary channel is within or outside the operating bandwidth for STAs 104 that do not enable DBE). The STA 104 may improve a signaling overhead by using the two sets of switching delay values (e.g., rather than triggering an action frame exchange when the DBE mode is enabled at the AP 102). If the AP 102 is operating with the DBE mode disabled, the AP 102 may select an NPCA switching delay to use for the STA 104 from the first set of values. Alternatively, if the AP 102 is operating with the DBE mode enabled, the AP 102 may select an NPCA switching delay to use for the STA 104 from the second set of values.

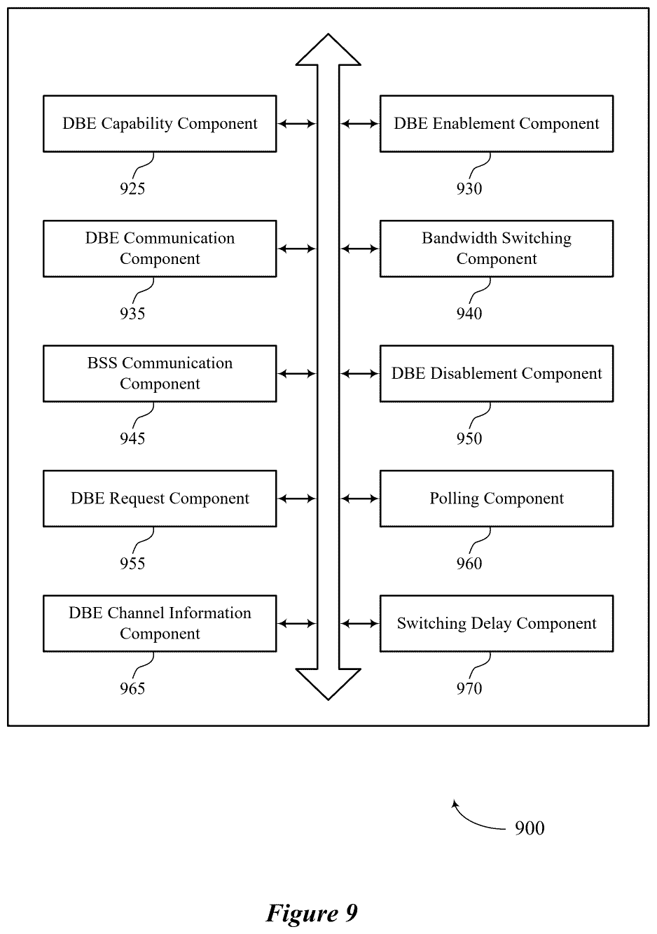

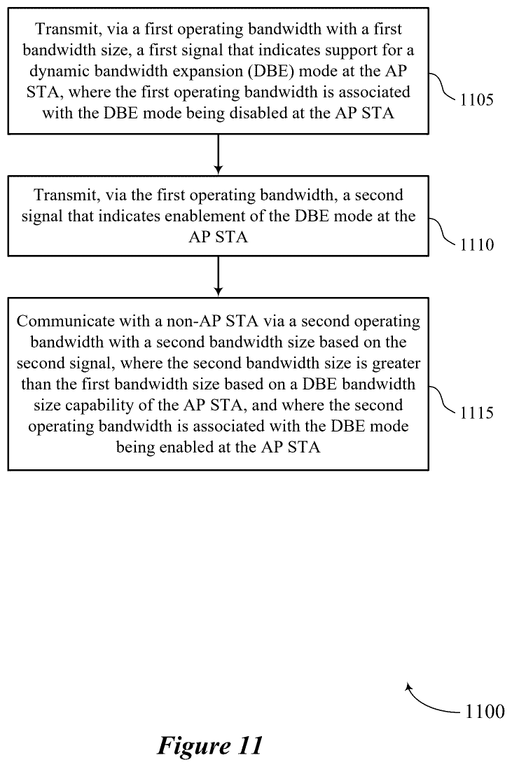

FIG. 9 shows a block diagram of an example wireless communication device 900 that supports signaling and operations for DBE. In some examples, the wireless communication device 900 is configured to perform the process 1100 described with reference to FIG. 11. The wireless communication device 900 (e.g., an AP STA, such as an AP 102 described with reference to FIG. 1-8) may include one or more chips, systems-on-chips (SoCs), chipsets, packages, components or devices that individually or collectively constitute or include a processing system. The processing system may interface with other components of the wireless communication device 900 and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in an AP, such as the AP 102 described with reference to FIG. 1. In some other examples, the wireless communication device 900 can be an AP that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes at least one external network interface coupled with the processing system that enables communication with a core network or backhaul network that enables the wireless communication device 900 to gain access to external networks including the Internet.

The wireless communication device 900 includes a DBE capability component 925, a DBE enablement component 930, a DBE communication component 935, a bandwidth switching component 940, a BSS communication component 945, a DBE disablement component 950, a DBE request component 955, a polling component 960, a DBE channel information component 965, and a switching delay component 970. Portions of one or more of the DBE capability component 925, the DBE enablement component 930, the DBE communication component 935, the bandwidth switching component 940, the BSS communication component 945, the DBE disablement component 950, the DBE request component 955, the polling component 960, the DBE channel information component 965, and the switching delay component 970 may be implemented at least in part in hardware or firmware. For example, one or more of the DBE capability component 925, the DBE enablement component 930, the DBE communication component 935, the bandwidth switching component 940, the BSS communication component 945, the DBE disablement component 950, the DBE request component 955, the polling component 960, the DBE channel information component 965, and the switching delay component 970 may be implemented at least in part by at least a processor or a modem. In some examples, portions of one or more of the DBE capability component 925, the DBE enablement component 930, the DBE communication component 935, the bandwidth switching component 940, the BSS communication component 945, the DBE disablement component 950, the DBE request component 955, the polling component 960, the DBE channel information component 965, and the switching delay component 970 may be implemented at least in part by a processor and software in the form of processor-executable code stored in memory.

The wireless communication device 900 may support wireless communication in accordance with examples as disclosed herein. The DBE capability component 925 is configurable or configured to transmit, via a first operating bandwidth with a first bandwidth size, a first signal that indicates support for a DBE mode at the AP STA, where the first operating bandwidth is associated with the DBE mode being disabled at the AP STA. The DBE enablement component 930 is configurable or configured to transmit, via the first operating bandwidth, a second signal that indicates enablement of the DBE mode at the AP STA. The DBE communication component 935 is configurable or configured to communicate with a non-AP STA via a second operating bandwidth with a second bandwidth size based on the second signal, where the second bandwidth size is greater than the first bandwidth size based on a DBE bandwidth size capability of the AP STA, and where the second operating bandwidth is associated with the DBE mode being enabled at the AP STA.

In some examples, the DBE enablement component 930 is configurable or configured to enable the DBE mode at the AP STA based on the second signal. In some examples, the bandwidth switching component 940 is configurable or configured to update an operating bandwidth of the AP STA from the first operating bandwidth to the second operating bandwidth based on the enabled DBE mode at the AP STA, where the communicating with the non-AP STA via the second operating bandwidth is further based on the updating the operating bandwidth of the AP STA.

In some examples, the second signal further indicates a time associated with the enablement of the DBE mode at the AP STA. In some examples, the operating bandwidth of the AP STA is updated from the first operating bandwidth to the second operating bandwidth at the time.

In some examples, the second signal includes a TBTT count value that indicates a TBTT corresponding to the time associated with the enablement of the DBE mode at the AP STA.

In some examples, the switching delay component 970 is configurable or configured to communicate an indication of one or more switching delays, where the operating bandwidth of the AP STA is updated from the first operating bandwidth to the second operating bandwidth based on a switching delay of the one or more switching delays.

In some examples, the one or more switching delays include a first switching delay from the DBE mode being disabled to the DBE mode being enabled and a second switching delay from the DBE mode being enabled to the DBE mode being disabled. In some other examples, the one or more switching delays include a set of multiple switching delays, where each switching delay of the set of multiple switching delays corresponds to a respective pair of operating bandwidths for switching.

In some examples, the bandwidth switching component 940 is configurable or configured to transmit a frame that blocks uplink transmissions for a time period, where the operating bandwidth of the AP STA is updated from the first operating bandwidth to the second operating bandwidth during at least a portion of the time period.

In some examples, the DBE enablement component 930 is configurable or configured to receive an action frame that indicates a first enablement of the DBE mode at the non-AP STA based on the DBE mode being disabled at the AP STA, where the communicating with the non-AP STA via the second operating bandwidth is further based on the first enablement of the DBE mode at the non-AP STA.

In some examples, the action frame further indicates one or more DBE mode parameters associated with the first enablement of the DBE mode at the non-AP STA.

In some examples, the one or more DBE mode parameters includes a switching delay from the first operating bandwidth to the second operating bandwidth at the non-AP STA based on the second signal.

In some examples, the action frame further indicates that the non-AP STA will switch to the second operating bandwidth at a first time associated with reception of the second signal or at a second time indicated by the second signal.

In some examples, the DBE enablement component 930 is configurable or configured to receive an action frame that indicates a second enablement of the DBE mode at the non-AP STA based on the DBE mode being enabled at the AP STA, where the communicating with the non-AP STA via the second operating bandwidth is further based on the second enablement of the DBE mode at the non-AP STA.

In some examples, the action frame further indicates one or more DBE mode parameters associated with the second enablement of the DBE mode at the non-AP STA.

In some examples, to support communicating, the DBE communication component 935 is configurable or configured to communicate one or more first frames with the non-AP STA via the second operating bandwidth based on the DBE mode being enabled at the AP STA and the non-AP STA. In some examples, to support communicating, the BSS communication component 945 is configurable or configured to communicate one or more second frames with a second non-AP STA via the first operating bandwidth based on the DBE mode being enabled at the AP STA and a non-DBE mode being enabled at the second non-AP STA.

In some examples, to support communicating with the non-AP STA via the second operating bandwidth, the DBE communication component 935 is configurable or configured to communicate an initial control frame. In some examples, to support communicating with the non-AP STA via the second operating bandwidth, the DBE communication component 935 is configurable or configured to communicate an initial control response based on the initial control frame. In some examples, to support communicating with the non-AP STA via the second operating bandwidth, the DBE communication component 935 is configurable or configured to communicate a frame based on the initial control response.

In some examples, the DBE disablement component 950 is configurable or configured to transmit, via the second operating bandwidth, a third signal that indicates disablement of the DBE mode at the AP STA. In some examples, the BSS communication component 945 is configurable or configured to communicate with the non-AP STA via the first operating bandwidth based on the third signal.

In some examples, the third signal further indicates a time associated with the disablement of the DBE mode at the AP STA, and the DBE disablement component 950 is configurable or configured to disable the DBE mode at the AP STA based on the third signal. In some examples, the third signal further indicates a time associated with the disablement of the DBE mode at the AP STA, and the bandwidth switching component 940 is configurable or configured to update an operating bandwidth of the AP STA from the second operating bandwidth to the first operating bandwidth at the time based on the disabled DBE mode at the AP STA, where the communicating with the non-AP STA via the first operating bandwidth is further based on the updating the operating bandwidth of the AP STA.

In some examples, the DBE request component 955 is configurable or configured to transmit an action frame that requests a second enablement of the DBE mode at the non-AP STA, where the communicating with the non-AP STA via the second operating bandwidth is further based on the action frame.

In some examples, the polling component 960 is configurable or configured to transmit a first frame that polls a set of multiple non-AP STAs for interest in the enablement of the DBE mode at the AP STA. In some examples, the polling component 960 is configurable or configured to receive one or more response frames based on the first frame, the one or more response frames indicating whether respective non-AP STAs request the enablement of the DBE mode at the AP STA, where the second signal is transmitted based on the one or more response frames.

In some examples, the DBE request component 955 is configurable or configured to receive a frame that requests the enablement of the DBE mode at the AP STA, where the second signal is transmitted based on the frame.

In some examples, the first signal further indicates the DBE bandwidth size capability of the AP STA.

In some examples, the first signal includes a UHR capabilities element that indicates the support for the DBE mode at the AP STA.

In some examples, the second signal further indicates a channel number associated with the second operating bandwidth, the second bandwidth size, or both.

In some examples, the DBE channel information component 965 is configurable or configured to transmit an indication of channel information associated with the DBE mode, the channel information indicating a first quantity of time that the AP STA operates at the first operating bandwidth, a second quantity of time that the AP STA operates at the second operating bandwidth, channel load information, subchannel load information, or any combination thereof.

In some examples, the DBE communication component 935 is configurable or configured to transmit an indication of a bitmap associated with DBE operation parameters, the bitmap indicating one or more disabled subchannels associated with the second operating bandwidth, where the communicating with the non-AP STA is further based on the one or more disabled subchannels.

In some examples, the second signal includes a UHR parameters element that indicates the enablement of the DBE mode at the AP STA.

In some examples, the second signal further indicates a channel switch for an NPCA primary channel from a first channel within the first operating bandwidth to a second channel outside the first operating bandwidth and within the second operating bandwidth.

In some examples, the switching delay component 970 is configurable or configured to receive, for a second non-AP STA that supports an NPCA mode, an indication of: a first NPCA switching delay associated with the NPCA primary channel being within an operating bandwidth of the second non-AP STA; and a second NPCA switching delay associated with the NPCA primary channel being outside the operating bandwidth of the second non-AP STA, where the first NPCA switching delay is different from the second NPCA switching delay.

In some examples, the first operating bandwidth includes a BSS operating bandwidth. In some examples, the second operating bandwidth includes a DBE operating bandwidth corresponding to the DBE bandwidth size capability of the AP STA or a subband of the DBE operating bandwidth.

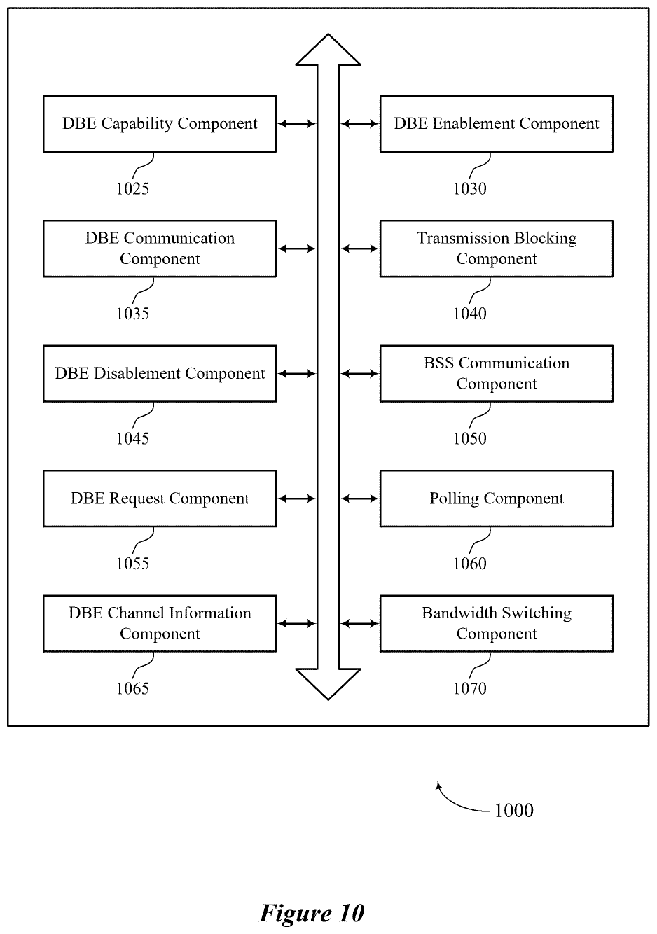

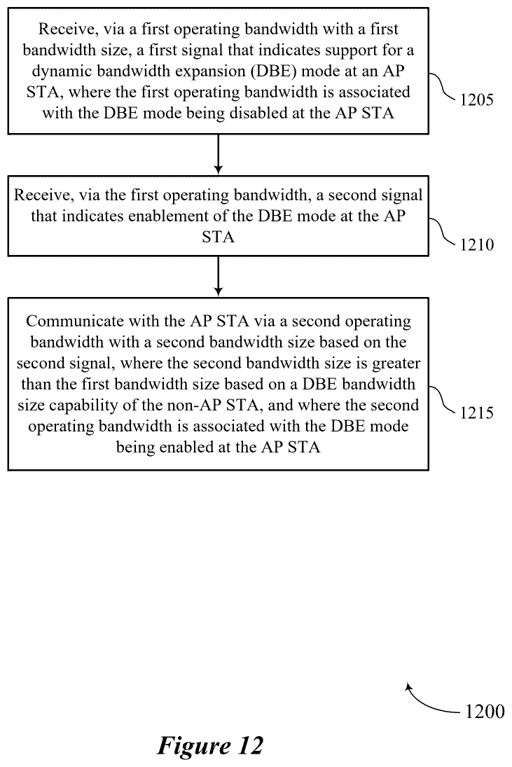

FIG. 10 shows a block diagram of an example wireless communication device 1000 that supports signaling and operations for DBE. In some examples, the wireless communication device 1000 is configured to perform the process 1200 described with reference to FIG. 12. The wireless communication device 1000 (e.g., a non-AP STA, such as a STA 104 described with reference to FIG. 1-8) may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as CPUs, GPUs, NPUs (also referred to as neural network processors or DLPs), or DSPs), processing blocks, ASIC, PLDs (such as FPGAs), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in a STA, such as the STA 104 described with reference to FIG. 1. In some other examples, the wireless communication device 1000 can be a STA that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a user interface (UI) (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system.

The wireless communication device 1000 includes a DBE capability component 1025, a DBE enablement component 1030, a DBE communication component 1035, a transmission blocking component 1040, a DBE disablement component 1045, a BSS communication component 1050, a DBE request component 1055, a polling component 1060, a DBE channel information component 1065, and a bandwidth switching component 1070. Portions of one or more of the DBE capability component 1025, the DBE enablement component 1030, the DBE communication component 1035, the transmission blocking component 1040, the DBE disablement component 1045, the BSS communication component 1050, the DBE request component 1055, the polling component 1060, the DBE channel information component 1065, and the bandwidth switching component 1070 may be implemented at least in part in hardware or firmware. For example, one or more of the DBE capability component 1025, the DBE enablement component 1030, the DBE communication component 1035, the transmission blocking component 1040, the DBE disablement component 1045, the BSS communication component 1050, the DBE request component 1055, the polling component 1060, the DBE channel information component 1065, and the bandwidth switching component 1070 may be implemented at least in part by at least a processor or a modem. In some examples, portions of one or more of the DBE capability component 1025, the DBE enablement component 1030, the DBE communication component 1035, the transmission blocking component 1040, the DBE disablement component 1045, the BSS communication component 1050, the DBE request component 1055, the polling component 1060, the DBE channel information component 1065, and the bandwidth switching component 1070 may be implemented at least in part by a processor and software in the form of processor-executable code stored in memory.

The wireless communication device 1000 may support wireless communication in accordance with examples as disclosed herein. The DBE capability component 1025 is configurable or configured to receive, via a first operating bandwidth with a first bandwidth size, a first signal that indicates support for a DBE mode at an AP STA, where the first operating bandwidth is associated with the DBE mode being disabled at the AP STA. The DBE enablement component 1030 is configurable or configured to receive, via the first operating bandwidth, a second signal that indicates enablement of the DBE mode at the AP STA. The DBE communication component 1035 is configurable or configured to communicate with the AP STA via a second operating bandwidth with a second bandwidth size based on the second signal, where the second bandwidth size is greater than the first bandwidth size based on a DBE bandwidth size capability of the non-AP STA, and where the second operating bandwidth is associated with the DBE mode being enabled at the AP STA.

In some examples, the DBE enablement component 1030 is configurable or configured to transmit an action frame that indicates a first enablement of the DBE mode at the non-AP STA based on the DBE mode being disabled at the AP STA, where the communicating with the AP STA via the second operating bandwidth is further based on the first enablement of the DBE mode at the non-AP STA.

In some examples, the action frame further indicates one or more DBE mode parameters associated with the first enablement of the DBE mode at the non-AP STA.

In some examples, the one or more DBE mode parameters includes a switching delay from the first operating bandwidth to the second operating bandwidth at the non-AP STA, and the bandwidth switching component 1070 is configurable or configured to update an operating bandwidth of the non-AP STA from the first operating bandwidth to the second operating bandwidth based on the second signal and the switching delay.

In some examples, the action frame further indicates that the non-AP STA will switch to the second operating bandwidth at a first time associated with reception of the second signal or at a second time indicated by the second signal.

In some examples, the DBE enablement component 1030 is configurable or configured to transmit an action frame that indicates a second enablement of the DBE mode at the non-AP STA based on the enablement of the DBE mode at the AP STA, where the communicating with the AP STA via the second operating bandwidth is further based on the second enablement of the DBE mode at the non-AP STA.

In some examples, the action frame further indicates one or more DBE mode parameters associated with the second enablement of the DBE mode at the non-AP STA.

In some examples, the transmission blocking component 1040 is configurable or configured to receive a frame that blocks uplink transmissions for a time period. In some examples, the transmission blocking component 1040 is configurable or configured to refrain from transmitting one or more frames to the AP STA during the time period, where the communicating with the AP STA via the second operating bandwidth is further based on the time period.

In some examples, the DBE capability component 1025 is configurable or configured to transmit, via the first operating bandwidth, a third signal that indicates support for the DBE mode at the non-AP STA, where the communicating with the AP STA via the second operating bandwidth is further based on the third signal.

In some examples, to support communicating with the AP STA via the second operating bandwidth, the DBE communication component 1035 is configurable or configured to communicate an initial control frame. In some examples, to support communicating with the AP STA via the second operating bandwidth, the DBE communication component 1035 is configurable or configured to communicate an initial control response based on the initial control frame. In some examples, to support communicating with the AP STA via the second operating bandwidth, the DBE communication component 1035 is configurable or configured to communicate a frame based on the initial control response.

In some examples, the DBE disablement component 1045 is configurable or configured to receive, via the second operating bandwidth, a third signal that indicates disablement of the DBE mode at the AP STA. In some examples, the BSS communication component 1050 is configurable or configured to communicate with the AP STA via the first operating bandwidth based on the third signal.

In some examples, the third signal further indicates a time associated with the disablement of the DBE mode at the AP STA, and the DBE disablement component 1045 is configurable or configured to disable the DBE mode at the non-AP STA based on the third signal. In some examples, the third signal further indicates a time associated with the disablement of the DBE mode at the AP STA, and the bandwidth switching component 1070 is configurable or configured to update an operating bandwidth of the non-AP STA from the second operating bandwidth to the first operating bandwidth at the time based on the disabled DBE mode at the non-AP STA, where the communicating with the AP STA via the first operating bandwidth is further based on the updating the operating bandwidth of the non-AP STA.

In some examples, the DBE request component 1055 is configurable or configured to receive an action frame that requests a second enablement of the DBE mode at the non-AP STA, where the communicating with the AP STA via the second operating bandwidth is further based on the action frame.

In some examples, the polling component 1060 is configurable or configured to receive a first frame that polls a set of multiple non-AP STAs for interest in the enablement of the DBE mode at the AP STA. In some examples, the polling component 1060 is configurable or configured to transmit a response frame based on the first frame, the response frame indicating that the non-AP STA requests the enablement of the DBE mode at the AP STA, where the second signal is received based on the response frame.

In some examples, the DBE request component 1055 is configurable or configured to transmit a frame that requests the enablement of the DBE mode at the AP STA, where the second signal is received based on the frame.

In some examples, the first signal further indicates a second DBE bandwidth size capability of the AP STA.

In some examples, the first signal includes a UHR capabilities element that indicates the support for the DBE mode at the AP STA.

In some examples, the second signal further indicates a channel number associated with the second operating bandwidth, the second bandwidth size, or both.

In some examples, the DBE channel information component 1065 is configurable or configured to receive an indication of channel information associated with the DBE mode, the channel information indicating a first quantity of time that the AP STA operates at the first operating bandwidth, a second quantity of time that the AP STA operates at the second operating bandwidth, channel load information, subchannel load information, or any combination thereof.

In some examples, the DBE communication component 1035 is configurable or configured to receive an indication of a bitmap associated with DBE operation parameters, the bitmap indicating one or more disabled subchannels associated with the second operating bandwidth, where the communicating with the AP STA is further based on the one or more disabled subchannels.

In some examples, the second signal includes a UHR parameters element that indicates the enablement of the DBE mode at the AP STA.

In some examples, the second signal further indicates a channel switch for an NPCA primary channel from a first channel within the first operating bandwidth to a second channel outside the first operating bandwidth and within the second operating bandwidth.

In some examples, the first operating bandwidth includes a BSS operating bandwidth. In some examples, the second operating bandwidth includes a DBE operating bandwidth corresponding to the DBE bandwidth size capability of the non-AP STA, or a subband of the DBE operating bandwidth.

FIG. 11 shows a flowchart illustrating an example process 1100 performable by or at an AP STA that supports signaling and operations for DBE. The operations of the process 1100 may be implemented by an AP STA or its components as described herein. For example, the process 1100 may be performed by a wireless communication device, such as the wireless communication device 900 described with reference to FIG. 9, operating as or within a wireless AP. In some examples, the process 1100 may be performed by a wireless AP, such as one of the APs 102 described with reference to FIG. 1.

In some examples, in 1105, the AP STA may transmit, via a first operating bandwidth with a first bandwidth size, a first signal that indicates support for a DBE mode at the AP STA, where the first operating bandwidth is associated with the DBE mode being disabled at the AP STA. In some implementations, aspects of the operations of 1105 may be performed by a DBE capability component 925 as described with reference to FIG. 9.

In some examples, in 1110, the AP STA may transmit, via the first operating bandwidth, a second signal that indicates enablement of the DBE mode at the AP STA. In some implementations, aspects of the operations of 1110 may be performed by a DBE enablement component 930 as described with reference to FIG. 9.

In some examples, in 1115, the AP STA may communicate with a non-AP STA via a second operating bandwidth with a second bandwidth size based on the second signal, where the second bandwidth size is greater than the first bandwidth size based on a DBE bandwidth size capability of the AP STA, and where the second operating bandwidth is associated with the DBE mode being enabled at the AP STA. In some implementations, aspects of the operations of 1115 may be performed by a DBE communication component 935 as described with reference to FIG. 9.

FIG. 12 shows a flowchart illustrating an example process 1200 performable by or at a non-AP STA that supports signaling and operations for DBE. The operations of the process 1200 may be implemented by a non-AP STA or its components as described herein. For example, the process 1200 may be performed by a wireless communication device, such as the wireless communication device 1000 described with reference to FIG. 10, operating as or within a wireless STA. In some examples, the process 1200 may be performed by a wireless STA, such as one of the STAs 104 described with reference to FIG. 1.

In some examples, in 1205, the non-AP STA may receive, via a first operating bandwidth with a first bandwidth size, a first signal that indicates support for a DBE mode at an AP STA, where the first operating bandwidth is associated with the DBE mode being disabled at the AP STA. In some implementations, aspects of the operations of 1205 may be performed by a DBE capability component 1025 as described with reference to FIG. 10.

In some examples, in 1210, the non-AP STA may receive, via the first operating bandwidth, a second signal that indicates enablement of the DBE mode at the AP STA. In some implementations, aspects of the operations of 1210 may be performed by a DBE enablement component 1030 as described with reference to FIG. 10.

In some examples, in 1215, the non-AP STA may communicate with the AP STA via a second operating bandwidth with a second bandwidth size based on the second signal, where the second bandwidth size is greater than the first bandwidth size based on a DBE bandwidth size capability of the non-AP STA, and where the second operating bandwidth is associated with the DBE mode being enabled at the AP STA. In some implementations, aspects of the operations of 1215 may be performed by a DBE communication component 1035 as described with reference to FIG. 10.

The following provides an overview of aspects of the present disclosure:

Aspect 1: A method for wireless communication at an AP STA, comprising: transmitting, via a first operating bandwidth with a first bandwidth size, a first signal that indicates support for a DBE mode at the AP STA, wherein the first operating bandwidth is associated with the DBE mode being disabled at the AP STA; transmitting, via the first operating bandwidth, a second signal that indicates enablement of the DBE mode at the AP STA; and communicating with a non-AP STA via a second operating bandwidth with a second bandwidth size based at least in part on the second signal, wherein the second bandwidth size is greater than the first bandwidth size based at least in part on a DBE bandwidth size capability of the AP STA, and wherein the second operating bandwidth is associated with the DBE mode being enabled at the AP STA.

Aspect 2: The method of aspect 1, further comprising: enabling the DBE mode at the AP STA based at least in part on the second signal; and updating an operating bandwidth of the AP STA from the first operating bandwidth to the second operating bandwidth based at least in part on the enabled DBE mode at the AP STA, wherein the communicating with the non-AP STA via the second operating bandwidth is further based at least in part on the updating the operating bandwidth of the AP STA.

Aspect 3: The method of aspect 2, wherein the second signal further indicates a time associated with the enablement of the DBE mode at the AP STA; and the operating bandwidth of the AP STA is updated from the first operating bandwidth to the second operating bandwidth at the time.

Aspect 4: The method of aspect 3, wherein the second signal comprises a TBTT count value that indicates a TBTT corresponding to the time associated with the enablement of the DBE mode at the AP STA.

Aspect 5: The method of any of aspects 2-4, further comprising: communicating an indication of one or more switching delays, wherein the operating bandwidth of the AP STA is updated from the first operating bandwidth to the second operating bandwidth based at least in part on a switching delay of the one or more switching delays.

Aspect 6: The method of aspect 5, wherein the one or more switching delays comprise: a first switching delay from the DBE mode being disabled to the DBE mode being enabled and a second switching delay from the DBE mode being enabled to the DBE mode being disabled, or a plurality of switching delays, wherein each switching delay of the plurality of switching delays corresponds to a respective pair of operating bandwidths for switching.

Aspect 7: The method of any of aspects 2-6, further comprising: transmitting a frame that blocks uplink transmissions for a time period, wherein the operating bandwidth of the AP STA is updated from the first operating bandwidth to the second operating bandwidth during at least a portion of the time period.

Aspect 8: The method of any of aspects 1-7, further comprising: receiving an action frame that indicates a first enablement of the DBE mode at the non-AP STA based at least in part on the DBE mode being disabled at the AP STA, wherein the communicating with the non-AP STA via the second operating bandwidth is further based at least in part on the first enablement of the DBE mode at the non-AP STA.

Aspect 9: The method of aspect 8, wherein the action frame further indicates one or more DBE mode parameters associated with the first enablement of the DBE mode at the non-AP STA.

Aspect 10: The method of aspect 9, wherein the one or more DBE mode parameters comprises a switching delay from the first operating bandwidth to the second operating bandwidth at the non-AP STA based at least in part on the second signal.

Aspect 11: The method of any of aspects 8-10, wherein the action frame further indicates that the non-AP STA will switch to the second operating bandwidth at a first time associated with reception of the second signal or at a second time indicated by the second signal.

Aspect 12: The method of any of aspects 1-7, further comprising: receiving an action frame that indicates a second enablement of the DBE mode at the non-AP STA based at least in part on the DBE mode being enabled at the AP STA, wherein the communicating with the non-AP STA via the second operating bandwidth is further based at least in part on the second enablement of the DBE mode at the non-AP STA.

Aspect 13: The method of aspect 12, wherein the action frame further indicates one or more DBE mode parameters associated with the second enablement of the DBE mode at the non-AP STA.

Aspect 14: The method of any of aspects 1-13, wherein the communicating comprises: communicating one or more first frames with the non-AP STA via the second operating bandwidth based at least in part on the DBE mode being enabled at the AP STA and the non-AP STA; and communicating one or more second frames with a second non-AP STA via the first operating bandwidth based at least in part on the DBE mode being enabled at the AP STA and a non-DBE mode being enabled at the second non-AP STA.

Aspect 15: The method of any of aspects 1-14, wherein the communicating with the non-AP STA via the second operating bandwidth comprises: communicating an initial control frame; communicating an initial control response based at least in part on the initial control frame; and communicating a frame based at least in part on the initial control response.

Aspect 16: The method of any of aspects 1-15, further comprising: transmitting, via the second operating bandwidth, a third signal that indicates disablement of the DBE mode at the AP STA; and communicating with the non-AP STA via the first operating bandwidth based at least in part on the third signal.

Aspect 17: The method of aspect 16, wherein the third signal further indicates a time associated with the disablement of the DBE mode at the AP STA, the method further comprising: disabling the DBE mode at the AP STA based at least in part on the third signal; and updating an operating bandwidth of the AP STA from the second operating bandwidth to the first operating bandwidth at the time based at least in part on the disabled DBE mode at the AP STA, wherein the communicating with the non-AP STA via the first operating bandwidth is further based at least in part on the updating the operating bandwidth of the AP STA.

Aspect 18: The method of any of aspects 1-17, further comprising: transmitting an action frame that requests a second enablement of the DBE mode at the non-AP STA, wherein the communicating with the non-AP STA via the second operating bandwidth is further based at least in part on the action frame.

Aspect 19: The method of any of aspects 1-18, further comprising: transmitting a first frame that polls a plurality of non-AP STAs for interest in the enablement of the DBE mode at the AP STA; and receiving one or more response frames based at least in part on the first frame, the one or more response frames indicating whether respective non-AP STAs request the enablement of the DBE mode at the AP STA, wherein the second signal is transmitted based at least in part on the one or more response frames.

Aspect 20: The method of any of aspects 1-19, further comprising: receiving a frame that requests the enablement of the DBE mode at the AP STA, wherein the second signal is transmitted based at least in part on the frame.

Aspect 21: The method of any of aspects 1-20, wherein the first signal further indicates the DBE bandwidth size capability of the AP STA.

Aspect 22: The method of any of aspects 1-21, wherein the first signal comprises a UHR capabilities element that indicates the support for the DBE mode at the AP STA.

Aspect 23: The method of any of aspects 1-22, wherein the second signal further indicates: a channel number associated with the second operating bandwidth, the second bandwidth size, or both.

Aspect 24: The method of any of aspects 1-23, further comprising: transmitting an indication of channel information associated with the DBE mode, the channel information indicating a first quantity of time that the AP STA operates at the first operating bandwidth, a second quantity of time that the AP STA operates at the second operating bandwidth, channel load information, subchannel load information, or any combination thereof.

Aspect 25: The method of any of aspects 1-24, further comprising: transmitting an indication of a bitmap associated with DBE operation parameters, the bitmap indicating one or more disabled subchannels associated with the second operating bandwidth, wherein the communicating with the non-AP STA is further based at least in part on the one or more disabled subchannels.

Aspect 26: The method of any of aspects 1-25, wherein the second signal comprises a UHR parameters element that indicates the enablement of the DBE mode at the AP STA.

Aspect 27: The method of any of aspects 1-26, wherein the second signal further indicates a channel switch for an NPCA primary channel from a first channel within the first operating bandwidth to a second channel outside the first operating bandwidth and within the second operating bandwidth.

Aspect 28: The method of aspect 27, further comprising: receiving, for a second non-AP STA that supports an NPCA mode, an indication of: a first NPCA switching delay associated with the NPCA primary channel being within an operating bandwidth of the second non-AP STA, and a second NPCA switching delay associated with the NPCA primary channel being outside the operating bandwidth of the second non-AP STA, wherein the first NPCA switching delay is different from the second NPCA switching delay.

Aspect 29: The method of any of aspects 1-28, wherein the first operating bandwidth comprises a BSS operating bandwidth; and the second operating bandwidth comprises: a DBE operating bandwidth corresponding to the DBE bandwidth size capability of the AP STA, or a subband of the DBE operating bandwidth.

Aspect 30: A method for wireless communication at a non-AP STA, comprising: receiving, via a first operating bandwidth with a first bandwidth size, a first signal that indicates support for a DBE mode at an AP STA, wherein the first operating bandwidth is associated with the DBE mode being disabled at the AP STA; receiving, via the first operating bandwidth, a second signal that indicates enablement of the DBE mode at the AP STA; and communicating with the AP STA via a second operating bandwidth with a second bandwidth size based at least in part on the second signal, wherein the second bandwidth size is greater than the first bandwidth size based at least in part on a DBE bandwidth size capability of the non-AP STA, and wherein the second operating bandwidth is associated with the DBE mode being enabled at the AP STA.

Aspect 31: The method of aspect 30, further comprising: transmitting an action frame that indicates a first enablement of the DBE mode at the non-AP STA based at least in part on the DBE mode being disabled at the AP STA, wherein the communicating with the AP STA via the second operating bandwidth is further based at least in part on the first enablement of the DBE mode at the non-AP STA.

Aspect 32: The method of aspect 31, wherein the action frame further indicates one or more DBE mode parameters associated with the first enablement of the DBE mode at the non-AP STA.

Aspect 33: The method of aspect 32, wherein the one or more DBE mode parameters comprises a switching delay from the first operating bandwidth to the second operating bandwidth at the non-AP STA, the method further comprising: updating an operating bandwidth of the non-AP STA from the first operating bandwidth to the second operating bandwidth based at least in part on the second signal and the switching delay.

Aspect 34: The method of any of aspects 31-33, wherein the action frame further indicates that the non-AP STA will switch to the second operating bandwidth at a first time associated with reception of the second signal or at a second time indicated by the second signal.

Aspect 35: The method of aspect 30, further comprising: transmitting an action frame that indicates a second enablement of the DBE mode at the non-AP STA based at least in part on the enablement of the DBE mode at the AP STA, wherein the communicating with the AP STA via the second operating bandwidth is further based at least in part on the second enablement of the DBE mode at the non-AP STA.

Aspect 36: The method of aspect 35, wherein the action frame further indicates one or more DBE mode parameters associated with the second enablement of the DBE mode at the non-AP STA.

Aspect 37: The method of any of aspects 30-36, further comprising: receiving a frame that blocks uplink transmissions for a time period; and refraining from transmitting one or more frames to the AP STA during the time period, wherein the communicating with the AP STA via the second operating bandwidth is further based at least in part on the time period.

Aspect 38: The method of any of aspects 30-37, further comprising: transmitting, via the first operating bandwidth, a third signal that indicates support for the DBE mode at the non-AP STA, wherein the communicating with the AP STA via the second operating bandwidth is further based at least in part on the third signal.

Aspect 39: The method of any of aspects 30-38, wherein the communicating with the AP STA via the second operating bandwidth comprises: communicating an initial control frame; communicating an initial control response based at least in part on the initial control frame; and communicating a frame based at least in part on the initial control response.

Aspect 40: The method of any of aspects 30-39, further comprising: receiving, via the second operating bandwidth, a third signal that indicates disablement of the DBE mode at the AP STA; and communicating with the AP STA via the first operating bandwidth based at least in part on the third signal.

Aspect 41: The method of aspect 40, wherein the third signal further indicates a time associated with the disablement of the DBE mode at the AP STA, the method further comprising: disabling the DBE mode at the non-AP STA based at least in part on the third signal; and updating an operating bandwidth of the non-AP STA from the second operating bandwidth to the first operating bandwidth at the time based at least in part on the disabled DBE mode at the non-AP STA, wherein the communicating with the AP STA via the first operating bandwidth is further based at least in part on the updating the operating bandwidth of the non-AP STA.

Aspect 42: The method of any of aspects 30-41, further comprising: receiving an action frame that requests a second enablement of the DBE mode at the non-AP STA, wherein the communicating with the AP STA via the second operating bandwidth is further based at least in part on the action frame.

Aspect 43: The method of any of aspects 30-42, further comprising: receiving a first frame that polls a plurality of non-AP STAs for interest in the enablement of the DBE mode at the AP STA; and transmitting a response frame based at least in part on the first frame, the response frame indicating that the non-AP STA requests the enablement of the DBE mode at the AP STA, wherein the second signal is received based at least in part on the response frame.

Aspect 44: The method of any of aspects 30-43, further comprising: transmitting a frame that requests the enablement of the DBE mode at the AP STA, wherein the second signal is received based at least in part on the frame.

Aspect 45: The method of any of aspects 30-44, wherein the first signal further indicates a second DBE bandwidth size capability of the AP STA.

Aspect 46: The method of any of aspects 30-45, wherein the first signal comprises a UHR capabilities element that indicates the support for the DBE mode at the AP STA.

Aspect 47: The method of any of aspects 30-46, wherein the second signal further indicates: a channel number associated with the second operating bandwidth, the second bandwidth size, or both.

Aspect 48: The method of any of aspects 30-47, further comprising: receiving an indication of channel information associated with the DBE mode, the channel information indicating a first quantity of time that the AP STA operates at the first operating bandwidth, a second quantity of time that the AP STA operates at the second operating bandwidth, channel load information, subchannel load information, or any combination thereof.

Aspect 49: The method of any of aspects 30-48, further comprising: receiving an indication of a bitmap associated with DBE operation parameters, the bitmap indicating one or more disabled subchannels associated with the second operating bandwidth, wherein the communicating with the AP STA is further based at least in part on the one or more disabled subchannels.

Aspect 50: The method of any of aspects 30-49, wherein the second signal comprises a UHR parameters element that indicates the enablement of the DBE mode at the AP STA.

Aspect 51: The method of any of aspects 30-50, wherein the second signal further indicates a channel switch for a non-primary channel access (NPCA) primary channel from a first channel within the first operating bandwidth to a second channel outside the first operating bandwidth and within the second operating bandwidth.

Aspect 52: The method of any of aspects 30-51, wherein the first operating bandwidth comprises a BSS operating bandwidth; and the second operating bandwidth comprises: a DBE operating bandwidth corresponding to the DBE bandwidth size capability of the non-AP STA, or a subband of the DBE operating bandwidth.

Aspect 53: An AP STA, comprising a processing system that includes processor circuitry and memory circuitry that stores code, the processing system configured to cause the AP STA to perform a method of any of aspects 1-29.

Aspect 54: An AP STA for wireless communication, comprising at least one means for performing a method of any of aspects 1-29.

Aspect 55: A non-transitory computer-readable medium storing code for wireless communication, the code comprising instructions executable by one or more processors to perform a method of any of aspects 1-29.

Aspect 56: A non-AP STA, comprising a processing system that includes processor circuitry and memory circuitry that stores code, the processing system configured to cause the non-AP STA to perform a method of any of aspects 30-52.

Aspect 57: A non-AP STA for wireless communication, comprising at least one means for performing a method of any of aspects 30-52.

Aspect 58: A non-transitory computer-readable medium storing code for wireless communication, the code comprising instructions executable by one or more processors to perform a method of any of aspects 30-52.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described herein as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described herein should not be understood as requiring such separation in all examples, and it should be understood that the described program components and systems can generally be integrated together in a single software product or packaged into multiple software products.

What is claimed is:

1. An access point (AP) station (STA), comprising:
a processing system that includes processor circuitry and memory circuitry that stores code, the processing system configured to cause the AP STA to:
transmit, via a first operating bandwidth with a first bandwidth size, a first signal that indicates support for a dynamic bandwidth expansion (DBE) mode at the AP STA, wherein the first operating bandwidth is associated with the DBE mode being disabled at the AP STA;
transmit, via the first operating bandwidth, a second signal that indicates enablement of the DBE mode at the AP STA; and
communicate with a non-AP STA via a second operating bandwidth with a second bandwidth size based at least in part on the second signal, wherein the second bandwidth size is greater than the first bandwidth size based at least in part on a DBE bandwidth size capability of the AP STA, and wherein the second operating bandwidth is associated with the DBE mode being enabled at the AP STA.

2. The AP STA of claim 1, wherein the processing system is further configured to cause the AP STA to:
enable the DBE mode at the AP STA based at least in part on the second signal; and
update an operating bandwidth of the AP STA from the first operating bandwidth to the second operating bandwidth based at least in part on the enabled DBE mode at the AP STA, wherein the communicating with the non-AP STA via the second operating bandwidth is further based at least in part on the updating the operating bandwidth of the AP STA.

3. The AP STA of claim 2, wherein:
the second signal further indicates a time associated with the enablement of the DBE mode at the AP STA; and
the operating bandwidth of the AP STA is updated from the first operating bandwidth to the second operating bandwidth at the time.

4. The AP STA of claim 3, wherein the second signal comprises a target beacon transmission time (TBTT) count value that indicates a TBTT corresponding to the time associated with the enablement of the DBE mode at the AP STA.

5. The AP STA of claim 1, wherein the processing system is further configured to cause the AP STA to:
receive an action frame that indicates a first enablement of the DBE mode at the non-AP STA based at least in part on the DBE mode being disabled at the AP STA, wherein the communicating with the non-AP STA via the second operating bandwidth is further based at least in part on the first enablement of the DBE mode at the non-AP STA.

6. The AP STA of claim 5, wherein the action frame further indicates one or more DBE mode parameters associated with the first enablement of the DBE mode at the non-AP STA.

7. The AP STA of claim 1, wherein the processing system is further configured to cause the AP STA to:
receive an action frame that indicates a second enablement of the DBE mode at the non-AP STA based at least in part on the DBE mode being enabled at the AP STA, wherein the communicating with the non-AP STA via the second operating bandwidth is further based at least in part on the second enablement of the DBE mode at the non-AP STA.

8. The AP STA of claim 7, wherein the action frame further indicates one or more DBE mode parameters associated with the second enablement of the DBE mode at the non-AP STA.

9. The AP STA of claim 1, wherein, to communicate, the processing system is configured to cause the AP STA to:
communicate one or more first frames with the non-AP STA via the second operating bandwidth based at least in part on the DBE mode being enabled at the AP STA and the non-AP STA; and
communicate one or more second frames with a second non-AP STA via the first operating bandwidth based at least in part on the DBE mode being enabled at the AP STA and a non-DBE mode being enabled at the second non-AP STA.

10. The AP STA of claim 1, wherein the processing system is further configured to cause the AP STA to:
transmit, via the second operating bandwidth, a third signal that indicates disablement of the DBE mode at the AP STA; and
communicate with the non-AP STA via the first operating bandwidth based at least in part on the third signal.

11. The AP STA of claim 10, wherein the third signal further indicates a time associated with the disablement of the DBE mode at the AP STA, and the processing system is further configured to cause the AP STA to:
disable the DBE mode at the AP STA based at least in part on the third signal; and
update an operating bandwidth of the AP STA from the second operating bandwidth to the first operating bandwidth at the time based at least in part on the disabled DBE mode at the AP STA, wherein the communicating with the non-AP STA via the first operating bandwidth is further based at least in part on the updating the operating bandwidth of the AP STA.

12. The AP STA of claim 1, wherein the first signal further indicates the DBE bandwidth size capability of the AP STA.

13. The AP STA of claim 1, wherein the first signal comprises an ultra-high reliability (UHR) capabilities element that indicates the support for the DBE mode at the AP STA.

14. The AP STA of claim 1, wherein the second signal comprises further indicates:
a channel number associated with the second operating bandwidth,
the second bandwidth size,
or both.

15. The AP STA of claim 1, wherein the processing system is further configured to cause the AP STA to:
transmit an indication of a bitmap associated with DBE operation parameters, the bitmap indicating one or more disabled subchannels associated with the second operating bandwidth, wherein the communicating with the non-AP STA is further based at least in part on the one or more disabled subchannels.

16. The AP STA of claim 1, wherein the second signal comprises an ultra-high reliability (UHR) parameters element that indicates the enablement of the DBE mode at the AP STA.

17. The AP STA of claim 1, wherein the second signal further indicates a channel switch for a non-primary channel access (NPCA) primary channel from a first channel within the first operating bandwidth to a second channel outside the first operating bandwidth and within the second operating bandwidth.

18. The AP STA of claim 1, wherein:
the first operating bandwidth comprises a basic service set (BSS) operating bandwidth; and
the second operating bandwidth comprises:
a DBE operating bandwidth corresponding to the DBE bandwidth size capability of the AP STA, or
a subband of the DBE operating bandwidth.

19. A non-access point (AP) station (STA), comprising:
a processing system that includes processor circuitry and memory circuitry that stores code, the processing system configured to cause the non-AP STA to:
receive, via a first operating bandwidth with a first bandwidth size, a first signal that indicates support for a dynamic bandwidth expansion (DBE) mode at an AP STA, wherein the first operating bandwidth is associated with the DBE mode being disabled at the AP STA;
receive, via the first operating bandwidth, a second signal that indicates enablement of the DBE mode at the AP STA; and
communicate with the AP STA via a second operating bandwidth with a second bandwidth size based at least in part on the second signal, wherein the second bandwidth size is greater than the first bandwidth size based at least in part on a DBE bandwidth size capability of the non-AP STA, and wherein the second operating bandwidth is associated with the DBE mode being enabled at the AP STA.

20. A method for wireless communication at an access point (AP) station (STA), comprising:
transmitting, via a first operating bandwidth with a first bandwidth size, a first signal that indicates support for a dynamic bandwidth expansion (DBE) mode at the AP STA, wherein the first operating bandwidth is associated with the DBE mode being disabled at the AP STA;
transmitting, via the first operating bandwidth, a second signal that indicates enablement of the DBE mode at the AP STA; and
communicating with a non-AP STA via a second operating bandwidth with a second bandwidth size based at least in part on the second signal, wherein the second bandwidth size is greater than the first bandwidth size based at least in part on a DBE bandwidth size capability of the AP STA, and wherein the second operating bandwidth is associated with the DBE mode being enabled at the AP STA.
